(19) United States
(12) Patent Application Publication
(10) Pub. No.: US 2025/0196345 A1
(43) Pub. Date: Jun. 19, 2025

(54) DYNAMIC AND VARIABLE DEFINITION OF ROBOT MISSIONS

(71) Applicant: Boston Dynamics, Inc., Waltham, MA (US)

(72) Inventors: Alexander C. Rice, Upper Arlington, OH (US); Brian Ringley, Copiague, NY (US); Christopher Michael Basmajian, San Francisco, CA (US); Colton Hurt, Glenpool, OK (US); Gordon Finnie, III, Newton, MA (US); Leland John Hepler, Lexington, MA (US)

(21) Appl. No.: 18/979,155

(22) Filed: Dec. 12, 2024

Related U.S. Application Data
(60) Provisional application No. 63/610,913, filed on Dec. 15, 2023.

(51) Int. Cl. B25J 9/16

(52) U.S. Cl. CPC B25J 9/1661; B25J 9/161; B25J 9/163; B25J 9/1653

(57) ABSTRACT

Systems and methods are described for dynamic and variable definition of robot missions and performance of the robot missions. A system can obtain first robot mission data associated with a first robot mission and second robot mission data. The second robot mission data may be associated with a second robot mission or a user-defined route edge. The system can generate composite mission data based on the first robot mission data and the second robot mission data. The system can instruct navigation of a robot through an environment according to the composite mission data.

### CROSS REFERENCE TO RELATED APPLICATION

This U.S. patent application claims priority under 35 U.S.C. § 119 (e) to U.S. Provisional Application No. 63/610,913, filed Dec. 15, 2023, which is considered part of the disclosure of this application and is hereby incorporated by reference in its entirety.

### TECHNICAL FIELD

This disclosure relates generally to robotics, and more specifically, to systems, methods, and apparatuses, including computer programs, for defining and executing missions.

### BACKGROUND

Robotic devices can autonomously or semi-autonomously navigate environments to perform a variety of tasks or functions. The robotic devices can utilize sensor data to navigate the environments. As robotic devices become more prevalent, there is a need to dynamically define and execute missions.

### SUMMARY

An aspect of the present disclosure provides a method. The method may include obtaining, by data processing hardware, first mission data associated with a first robot mission. The method may further include obtaining, by the data processing hardware, second mission data associated with a second robot mission. The method may further include generating, by the data processing hardware, composite mission data based on the first mission data and the second mission data. The composite mission data may include at least a portion of the first mission data and at least a portion of the second mission data. The method may further include instructing, by the data processing hardware, navigation of at least one robot according to the composite mission data.

In various embodiments, the method may further include identifying one or more characteristics of the at least one robot. The method may further include verifying the composite mission data based on the one or more characteristics.

In various embodiments, the method may further include identifying one or more characteristics of the at least one robot. The one or more characteristics may be indicative of one or more sensors of the at least one robot. The method may further include verifying the composite mission data based on the one or more characteristics.

In various embodiments, the method may further include identifying one or more characteristics of the at least one robot. The one or more characteristics may be indicative of an arm of the at least one robot. The method may further include verifying the composite mission data based on the one or more characteristics.

In various embodiments, the method may further include identifying one or more characteristics of the at least one robot. The one or more characteristics may be indicative of a gripper of the at least one robot. The method may further include verifying the composite mission data based on the one or more characteristics.

In various embodiments, the method may further include identifying one or more characteristics of the at least one robot. The one or more characteristics may be indicative of one or more processing units of the at least one robot. The method may further include verifying the composite mission data based on the one or more characteristics.

In various embodiments, the method may further include identifying one or more characteristics of the at least one robot. The one or more characteristics may be indicative of one or more processing capabilities or sensing capabilities of the at least one robot. The method may further include verifying the composite mission data based on the one or more characteristics.

In various embodiments, the method may further include identifying one or more characteristics of the at least one robot. The method may further include comparing the one or more characteristics with at least a portion of the composite mission data. The method may further include instructing display of a user interface based on comparing the one or more characteristics with at least a portion of the composite mission data. The user interface may include an alert.

In various embodiments, the first robot mission may be associated with a first robot. The second robot mission may be associated with a second robot.

In various embodiments, the first robot mission may be associated with a first robot. The second robot mission may be associated with a second robot. The at least one robot may include at least one of the first robot or the second robot.

In various embodiments, the first robot mission may be associated with a first robot. The second robot mission may be associated with a second robot. The at least one robot may include a third robot.

In various embodiments, the first robot mission may be associated with a first robot. The second robot mission may be associated with a second robot. The first robot may have one or more first characteristics. The second robot may have one or more second characteristics.

In various embodiments, the first mission data may be indicative of one or more waypoints, one or more edges, and one or more actions.

In various embodiments, the first mission data may be indicative of one or more waypoints, one or more edges, and one or more actions. The first mission data may link a first waypoint of the one or more waypoints to a second waypoint of the one or more waypoints via a first edge of the one or more edges. The first mission data may indicate a first action is associated with the second waypoint.

In various embodiments, the first mission data may correspond to an environment. The method may further include recording the first robot mission based on traversal of the environment by a robot.

In various embodiments, the first mission data may correspond to an environment. The method may further include recording the first robot mission based on traversal of the environment by a robot. The first mission data may be indicative of the traversal of the environment by the robot.

In various embodiments, the first mission data may correspond to an environment. The method may further include recording the first robot mission based on traversal of the environment by a robot. The first mission data may be indicative of the traversal of the environment by the robot and one or more actions performed by the robot.

In various embodiments, the first mission data may correspond to an environment. The method may further include recording the first robot mission based on traversal of the environment by a robot. The first mission data may be indicative of the traversal of the environment by the robot and one or more interactions by the robot with the environment.

In various embodiments, the method may further include obtaining, via a user computing device, input indicative of an edge between one or more waypoints. The one or more waypoints may be based on at least one of the first mission data or the second mission data. Generating the composite mission data may further be based on the input.

In various embodiments, at least one of the first mission data or the second mission data may indicate one or more first edges between a first waypoint and a second waypoint. The method may further include obtaining, via a user computing device, input indicative of a second edge between the first waypoint and the second waypoint. Generating the composite mission data may further be based on the input.

In various embodiments, at least one of the first mission data and the second mission data may indicate a first edge between a first waypoint and a second waypoint and a second edge between the second waypoint and a third waypoint. The method may further include obtaining, via a user computing device, input indicative of a third edge between the first waypoint and the third waypoint. Generating the composite mission data may further be based on the input.

In various embodiments, the method may further include obtaining, via a user computing device, input indicative of the at least a portion of the first mission data and the at least a portion of the second mission data.

In various embodiments, the method may further include obtaining, via a user computing device, input indicative of the at least a portion of the first mission data and the at least a portion of the second mission data. The at least a portion of the first mission data may include one or more first waypoints and one or more first actions. The at least a portion of the second mission data may include one or more second waypoints and one or more second actions.

In various embodiments, the method may further include obtaining, via a user computing device, input indicative of the at least a portion of the first mission data and the at least a portion of the second mission data. The at least a portion of the first mission data may include one or more first waypoints and one or more first actions. The at least a portion of the second mission data may include one or more second waypoints and one or more second actions. The composite mission data may include the one or more first waypoints, the one or more second waypoints, the one or more first actions, and the one or more second actions.

In various embodiments, the method may further include obtaining, via a user computing device, input indicative of the at least a portion of the first mission data and the at least a portion of the second mission data and an order of performance. The at least a portion of the first mission data may include one or more first waypoints and one or more first actions. The at least a portion of the second mission data may include one or more second waypoints and one or more second actions. The composite mission data may include the one or more first waypoints, the one or more second waypoints, the one or more first actions, and the one or more second actions based on the order of performance.

In various embodiments, the first mission data may include a first edge between a first waypoint and a second waypoint and a second edge between the second waypoint and a third waypoint. The second mission data may include a third edge between the third waypoint and a fourth waypoint and a fourth edge between the fourth waypoint and a fifth waypoint. The composite mission data may include a fifth edge between the first waypoint and the fifth waypoint.

In various embodiments, the first robot mission may include a mission to navigate from a first waypoint to a second waypoint. The second robot mission may include a mission to navigate from the second waypoint to a third waypoint. The composite mission data may be associated with a third robot mission that may include a mission to navigate from the first waypoint to the second waypoint and from the second waypoint to the third waypoint.

In various embodiments, the first robot mission may include a mission to navigate from a first waypoint to a second waypoint and from the second waypoint to a third waypoint. The second robot mission may include a mission to navigate from a fourth waypoint to the second waypoint and from the second waypoint to a fifth waypoint. The composite mission data may be associated with a third robot mission that may include a mission to navigate from the first waypoint to the second waypoint and from the second waypoint to the fifth waypoint.

In various embodiments, the first robot mission may include a mission to perform a first action and a second action. The second robot mission may include a mission to perform a third action and a fourth action. The composite mission data may be associated with a third robot mission that may include a mission to perform the first action and the fourth action.

In various embodiments, the first robot mission may include a mission to first perform a first action and second perform a second action. The second robot mission may include a mission to first perform a third action and second perform a fourth action. The composite mission data may be associated with a third robot mission that may include a mission to first perform the fourth action and second perform the first action.

In various embodiments, the method may further include obtaining, via a user computing device, input indicative of one or more first waypoints and one or more second waypoints. The composite mission data may include the one or more second waypoints.

In various embodiments, the method may further include obtaining, via a user computing device, input indicative of one or more first waypoints and one or more second waypoints. The composite mission data may include the one or more second waypoints. The composite mission data may exclude the one or more first waypoints.

In various embodiments, the method may further include obtaining, via a user computing device, input indicative of one or more first edges and one or more second edges. The composite mission data may include the one or more second edges.

In various embodiments, the method may further include obtaining, via a user computing device, input indicative of one or more first edges and one or more second edges. The composite mission data may include the one or more second edges. The composite mission data may exclude the one or more first edges.

In various embodiments, the first mission and the second mission may be associated with a fiducial.

In various embodiments, the method may further include verifying that the first mission and the second mission are associated with a common fiducial.

In various embodiments, the method may further include storing the composite mission data in memory.

In various embodiments, the method may further include instructing display of a user interface. The user interface may reflect the composite mission.

In various embodiments, the method may further include obtaining input indicative of at least one of a scale or a resolution. The method may further include instructing display of a user interface according to the at least one of the scale or the resolution. The user interface may reflect the composite mission overlaid on an environment model.

In various embodiments, the method may further include instructing display of a user interface. The user interface may reflect a representation of the composite mission overlaid on an environment model.

According to various embodiments of the present disclosure, a system may include data processing hardware and memory in communication with the data processing hardware. The memory may store instructions that when executed on the data processing hardware cause the data processing hardware to obtain first mission data associated with a first robot mission. Execution of the instruction may further cause the data processing hardware to obtain second mission data associated with a second robot mission. Execution of the instruction may further cause the data processing hardware to generate composite mission data based on the first mission data and the second mission data. The composite mission data may include at least a portion of the first mission data and at least a portion of the second mission data. Execution of the instruction may further cause the data processing hardware to instruct navigation of at least one robot according to the composite mission data.

In various embodiments, the system may include any combination of the above features.

According to various embodiments of the present disclosure, a robot may include at least two legs, data processing hardware, and memory in communication with the data processing hardware. The memory may store instructions that when executed on the data processing hardware cause the data processing hardware to obtain first mission data associated with a first robot mission. Execution of the instruction may further cause the data processing hardware to obtain second mission data associated with a second robot mission. Execution of the instruction may further cause the data processing hardware to generate composite mission data based on the first mission data and the second mission data. The composite mission data may include at least a portion of the first mission data and at least a portion of the second mission data. Execution of the instruction may further cause the data processing hardware to instruct navigation of the robot using the at least two legs according to the composite mission data.

In various embodiments, the robot may include any combination of the above features.

According to various embodiments of the present disclosure, a method may include obtaining, by data processing hardware of a mobile robot, mission data indicative of a mission. The method may further include identifying, by the data processing hardware, one or more characteristics of the mobile robot. The method may further include verifying, by the data processing hardware, the mission data based on the one or more characteristics. The method may further include instructing, by the data processing hardware, navigation by the mobile robot according to the mission data based on verifying the mission data.

According to various embodiments of the present disclosure, a method may include obtaining, by data processing hardware, an environment model associated with an environment. The method may further include obtaining, by the data processing hardware, first sensor data captured from the environment by at least one sensor of one or more robots. The method may further include obtaining, by the data processing hardware, second sensor data captured from the environment by the at least one sensor of the one or more robots. The method may further include generating, by the data processing hardware, a first virtual representation of the first sensor data and a second virtual representation of the second sensor data. The method may further include instructing, by the data processing hardware, display of a user interface. The user interface may reflect the first virtual representation and the second virtual representation overlaid on the environment model.

According to various embodiments of the present disclosure, a method may include identifying, by data processing hardware, an environment. The method may further include identifying, by the data processing hardware, a set of actions and a set of waypoints associated with the environment. The method may further include instructing, by the data processing hardware, display of a user interface. The user interface may reflect the set of actions and the set of waypoints. The method may further include obtaining, by the data processing hardware, a selection of at least one of a portion of the set of actions or a portion of the set of waypoints. The method may further include instructing, by the data processing hardware, navigation by a mobile robot according to the at least one of the portion of the set of actions or the portion of the set of waypoints.

According to various embodiments of the present disclosure, a method may include obtaining, by data processing hardware, mission data associated with a robot mission, the mission data indicative of one or more parameters of the robot mission. The method may further include obtaining, by the data processing hardware, an input indicative of one or more edits to the one or more parameters of the robot mission. The method may further include generating, by the data processing hardware, edited mission data based on the input. The method may further include instructing, by the data processing hardware, navigation by at least one robot according to the edited mission data.

In various embodiments, the one or more parameters of the robot mission may include an order of performance.

In various embodiments, the one or more parameters of the robot mission may include one or more waypoints.

In various embodiments, the one or more parameters of the robot mission may include one or more waypoints. The one or more edits may include one or more edits to one or more positions of the one or more waypoints with respect to an environment model.

In various embodiments, the one or more parameters of the robot mission may include one or more edges.

In various embodiments, the one or more parameters of the robot mission may include one or more actions associated with a waypoint.

In various embodiments, the one or more parameters of the robot mission may include one or more editable parameters of the robot mission. The method may further include identifying the one or more parameters of the robot mission. The method may further include instructing display of a user interface indicative of the one or more parameters of the robot mission. Obtaining the input may include obtaining the input via the user interface.

According to various embodiments of the present disclosure, a method may include obtaining, by data processing hardware, first mission data indicative of a first mission. The first mission may be associated with one or more actions, one or more waypoints, and one or more first edges between the one or more waypoints. The method may further include obtaining, by the data processing hardware, an input indicative of a second edge between the one or more waypoints. The method may further include dynamically generating, by the data processing hardware, second mission data based on the first mission data and the input. The method may further include instructing, by the data processing hardware, navigation by a mobile robot according to the second mission data.

According to various embodiments of the present disclosure, a method may include obtaining, by data processing hardware, mission data associated with a first robot mission of a first robot. The method may further include instructing, by the data processing hardware, display of a user interface based on the mission data. The method may further include obtaining, by the data processing hardware, an input via the user interface. The method may further include instructing, by the data processing hardware, navigation of a second robot according to the mission data and based on the input.

According to various embodiments of the present disclosure, a method may include obtaining, by data processing hardware, first mission data associated with a first robot mission. The method may further include obtaining, by the data processing hardware, an input via a first user interface. The method may further include dynamically defining, by the data processing hardware, a second robot mission based on the input and the first robot mission. The method may further include instructing, by the data processing hardware, display of a second user interface based on second mission data associated with the second robot mission.

According to various embodiments of the present disclosure, a method may include obtaining, by data processing hardware, an input defining a route waypoint using a one or more coordinates. The method may further include dynamically defining, by the data processing hardware, a robot mission based on the input. The method may further include instructing, by the data processing hardware, navigation by the robot according to the robot mission.

According to various embodiments of the present disclosure, a robot may include at least two legs, data processing hardware, and memory in communication with the data processing hardware. The memory may store instructions that when executed on the data processing hardware cause the data processing hardware to perform any combination of the above features.

According to various embodiments of the present disclosure, a system may include data processing hardware and memory in communication with the data processing hardware. The memory may store instructions that when executed on the data processing hardware cause the data processing hardware to perform any combination of the above features.

The details of the one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example robot for navigating about an environment.

FIG. 1B is a schematic view of one embodiment of a sensor pointing system for pointing a sensor of the robot of FIG. 1A.

FIG. 2 is a schematic view of a robot with a sensor pointing system according to one embodiment.

FIG. 3 is a schematic view of a robot navigating to a point of interest to capture sensor data according to one embodiment.

FIG. 4 is a schematic view of a robot in communication with a remote system.

FIG. 5 is a schematic view of exemplary route waypoints and route edges of a robot.

FIG. 6A is a schematic view of an example user interface indicating an environment.

FIG. 6B is a schematic view of an example user interface indicating a mission of a robot in an environment.

FIG. 6C is a schematic view of an example user interface indicating a mission of a robot in an environment.

FIG. 6D is a schematic view of an example user interface indicating a mission of a robot in an environment.

FIG. 7A is a schematic view of an example user interface indicating an environment and waypoint operations.

FIG. 7B is a schematic view of an example user interface indicating an environment and edge operations.

FIG. 7C is a schematic view of an example user interface indicating an environment and edge operations.

FIG. 7D is a schematic view of an example user interface indicating an environment and mission operations.

FIG. 8 is a schematic view of an example user interface indicating an environment and a composite mission.

FIG. 9 is a schematic view of an example user interface indicating an environment and a composite mission.

FIG. 10 is a flowchart of an example arrangement of operations for generating and executing a mission.

FIG. 11 is a schematic view of an example computing device that may be used to implement the systems and methods described herein.

FIG. 12 is a schematic view of a robot with a sensor pointing system according to another embodiment.

Like reference symbols in the various drawings indicate like elements.

### DETAILED DESCRIPTION

Generally described, autonomous and semi-autonomous robots can utilize mapping, localization, and/or navigation systems to map an environment (e.g., a site) utilizing sensor data obtained by the robots. Further, the robots can utilize the systems to perform navigation and/or localization in the environment. The systems can further define (e.g., generate) a mission (e.g., a robot mission, an inspection mission, a navigation mission, etc.) during navigation in the environment such that the robots can subsequently execute the mission.

The present disclosure relates to the use of mission data (e.g., sensor data, route data, action data, etc.) obtained by a system to define (e.g., dynamically) a mission. A system can obtain mission data associated with multiple missions. For example, the system can obtain first mission data associated with a first mission and second mission data associated with a second mission.

Based on the mission data, the system can enable the dynamic and variable generation of mission data (e.g., composite mission data) and definition of a corresponding mission (e.g., a composite mission). The generation of mission data and definition of the mission may be dynamic and/or variable in that the manner in which the mission data is processed (e.g., filtered, merged, etc.) to generate composite mission data may be dynamic and/or variable (e.g., defined by a user). For example, the system can process the mission data in different manners (e.g., a variable manner) by filtering, merging, etc. the mission data to generate mission data. In another example, the system can apply a first filter to the mission data to generate first composite mission data and can apply a second filter to the mission data to generate second composite mission data.

Specifically, the system can combine (e.g., fuse, merge, join, append, blend, unite, etc.) mission data associated with a set of missions to generate composite mission data (e.g., composite data, merged data, merged mission data, filtered data, filtered mission data, etc.). For example, the system can generate composite mission data indicative of a single mission (e.g., a composite mission, a merged mission, a filtered mission, etc.) based on mission data associated with multiple missions. The composite mission data can be indicative of a customized mission, an ad hoc mission, a personalized mission, etc.

By combining mission data associated with a set of missions to generate composite mission data, the system can instruct (e.g., command, control, etc.) a robot to execute a first portion (e.g., a first subset) of a first mission and a second portion of a second mission during the same mission (e.g., a third mission, a composite mission, etc.). In some cases, the system may generate instructions and provide (e.g., output) the instructions to a system (e.g., to a robot, a different computing system, etc.). The system may execute the instructions and may perform one or more actions based on obtaining the instructions from the computing system. For example, the robot may execute a first portion of a first mission and a second portion of a second mission.

In an illustrative example, the first mission data can include or be indicative of a first action to turn a lever located in a first portion of an environment, a second action to navigate from the first portion of the environment to a second portion of the environment, and a third action to open a door. Additionally, the second mission data can include or be indicative of a fourth action to capture first sensor data indicative of a gauge reading at the first portion of the environment, a fifth action to navigate from the first portion of the environment to a third portion of the environment, and a sixth action to capture second sensor data indicative of a valve position at the third portion of the environment. Further, the composite mission data may include the first action and the fourth action (but may not include the second action or the third action).

Therefore, the system can merge mission data (e.g., in a mix and match manner) such that at least a portion of first mission data can be combined with at least a portion of second mission data.

In traditional systems, while systems may generate mission data associated with a mission, the mission data may be based on traversal of the environment by the robot and a prior recording session (e.g., recording execution of a mission) of the robot. The robot may execute a recording session during which the robot can traverse the environment and perform a series of actions. For example, a robot may traverse an environment, perform a series of actions, and generate mission data defining a mission based on the series of actions (e.g., the mission data may include or be indicative of each of the series of actions). Such a recording session may include executing a mission, recording the executed mission, and storing the recorded mission as mission data. Additionally, such a recording session may be based on a user (e.g., manually) guiding the robot through the environment and identifying actions for the robot to perform.

Such traditional systems may store mission data associated with the mission such that the previously executed mission can be subsequently executed by the robot. Therefore, such systems may be limited to instructing execution of missions by a robot that were previously recorded and executed by the same robot (in its entirety). Such systems may be limited to instructing execution of a mission in the entirety of the mission (e.g., such systems may be unable to instruct execution of a portion of the actions indicated by the mission data). In such systems, the execution of missions by a robot may be based on first recording the specific mission by the specific robot.

In some cases, the traditional systems may be unable to instruct execution of a mission by a first robot if the mission is recorded by a second robot and not the first robot. For example, the traditional systems may be unable to have mission crossover between robots and instead, in traditional systems, the same robot may perform the mission recording and the mission execution. In another example, a first robot may be unable to execute a mission recorded by a second robot without separately recording the mission. The use of such systems may be inefficient as such systems may require the same robot to perform both the mission recording and the mission execution. Additionally, the use of such systems may result in multiple robots recording the same mission which may cause issues as unintended deviations may occur in the recordings of the mission such that the robots execute different missions.

In some cases, a user may attempt to manually define a series of actions for the robot to perform. However, such a process may be inefficient and error prone as the robot may be associated with a set of actions and environments such that the user may be unable to correctly identify how to perform actions in particular environments. Instead, the user may implement a trial-and-error process to identify how to perform actions in particular environments. Implementing such a manual trial-and-error process may be time intensive and may cause delays in mission recording and mission execution by the robot.

As components (e.g., mobile robots) proliferate, the demand for more dynamic, variable, and effective mission definition and execution within an environment has increased. Specifically, the demand has increased for a system to be able to dynamically generate missions for execution by a robot without separately recording the mission by the robot.

The present disclosure provides systems and methods (e.g., computer-implemented methods) that enable an increase in the effectiveness of mission execution using a dynamic and variable definition of the mission. The present disclosure separates the mission recordation and the mission execution such that the same or different robots can perform the mission recordation and the mission execution. For example, the present disclosure may separate the mission recordation and the mission execution by introducing a separate mission definition process (e.g., between the mission recordation and the mission execution) such that missions may be defined based on previously recorded missions (e.g., without explicitly recording the defined mission). Such a separation enables missions (or corresponding mission data) to be shared between robots without separately performing a mission recordation at each of the robots. The present disclosure further enables an increase in the efficiency of mission execution by generating first mission data defining a first mission based on at least a portion of second mission data defining a second mission (e.g., without separately recording the first mission).

The methods and apparatus described herein enable a system to generate composite mission data and define a composite mission based on first mission data and second mission data. The system can obtain mission data indicative of (e.g., defining) a mission by a robot. The mission data may be based one or more parameters. The one or more parameters may include position data, one or more actions (e.g., performed by a robot), sensor data, etc. For example, the parameters of the mission data may include one or more route waypoints, one or more route edges connecting the one or more routes waypoints, one or more actions associated with all or a portion of the one or more route waypoints and/or the one or more route edges, etc.

The mission data may be associated with (e.g., indicative of) a mission by a robot. For example, a robot may execute the mission (e.g., navigate an environment and perform one or more actions) and store mission data based on executing the mission. In some cases, the robot can store the mission data in a data store. For example, the robot can store the mission data in a data store associated with multiple robots.

The system can identify mission data associated with one or more missions (e.g., one or more portions of the mission data associated with one or more missions). For example, the system can identify first mission data associated with a first mission and second mission data associated with a second mission. In some cases, the first mission data may be associated with a first mission of a first robot (e.g., executed by the first robot) and the second mission data may be associated with a second mission of a second robot (e.g., executed by the second robot).

Based on the identified mission data, the system can generate composite mission data. For example, the system can generate composite mission data based on first mission data associated with a first mission and second mission data associated with a second mission. In another example, the system can generate composite mission data based on first mission data associated with a first mission and an input. The input may include user-defined data (e.g., a user-defined route waypoint, a user-defined route edge, a user-defined action, etc.). For example, the system may instruct display of a user interface such that a user can provide an input defining a route edge, a route waypoint, an action, etc. for composite mission data. Based on the input received via the user interface, the system can generate the composite mission data.

To generate the composite mission data, the system can merge the identified mission data. The system can merge the identified mission data (e.g., a first portion of mission data associated with a first mission and a second portion of mission data associated with a second mission data) associated with multiple missions to generate the composite mission data. Therefore, the system can merge mission data associated with different missions to generate composite mission data associated with a mission.

The system may merge the identified mission data by integrating mission data from different portions of the mission data (e.g., associated with different missions) and eliminating duplicative and/or inconsistent data. For example, the system may remove data that is duplicated in multiple portions of the mission data. In another example, the system may merge the mission data such that the composite mission data includes at least a portion of first mission data associated with a first mission and at least a portion of second mission data associated with a second mission.

As discussed above, the system can store the composite mission data for execution of a corresponding mission defined by the composite mission data. The system can instruct a robot to navigate in an environment according to the composite mission data (e.g., execute a mission based on the composite mission data). In some cases, the composite mission data may be based on mission data defining one or more missions associated with one or more robots and the system can instruct a robot of the one or more robots to navigate in an environment according to the composite mission data. In some cases, the composite mission data may be based on mission data defining one or more missions associated with one or more first robots and the system can instruct one or more second robots to navigate in an environment according to the composite mission data.

In some cases, the system can verify the composite mission data (e.g., one or more parameters of the composite mission data) and/or one or more characteristics of the robot. For example, the one or more parameters of the composite mission data may include sensor data, action data (e.g., one or more actions), route data (e.g., one or more route waypoints, one or more route edges, etc.) and the one or more characteristics may include one or more sensors, appendages, memory, processing units, processing power, processing speed, processing capabilities, sensing power, sensing speed, sensing capabilities, etc. associated with the robot. For example, the system can verify that the robot is capable of executing all or a portion of a mission based on the composite mission data (e.g., if the mission data includes an action to obtain a camera image, that the robot includes or is associated with an image sensor, if the mission data includes an action to obtain point cloud data, that the robot includes or is associated with a lidar sensor, etc.).

In some cases, the system may determine that the robot can execute all or a portion of the mission and/or cannot execute all or a portion of the mission (e.g., is unavailable, does not satisfy the one or more characteristics, etc.). For example, the system may determine that the robot can execute a first portion of the mission that is based on mission data including an action to obtain a camera image but cannot execute a second portion of the mission that is based on mission data including an action to obtain a point cloud. Based on determining that the robot can execute all or a portion of the mission, the system may instruct navigation by the robot according to all or a portion of the composite mission data. In some cases, based on determining that the robot cannot execute all or a portion of the mission, the system may not instruct navigation by the robot according to the composite mission data. In some cases, based on determining that the robot can execute a first portion of the mission and cannot execute a second portion of the mission, the system may filter the second portion from the mission (e.g., filter a corresponding portion of the composite mission data from the composite mission data to obtain filtered mission data) and may instruct the robot to execute the filtered mission (e.g., may instruct navigation by the robot according to filtered mission data).

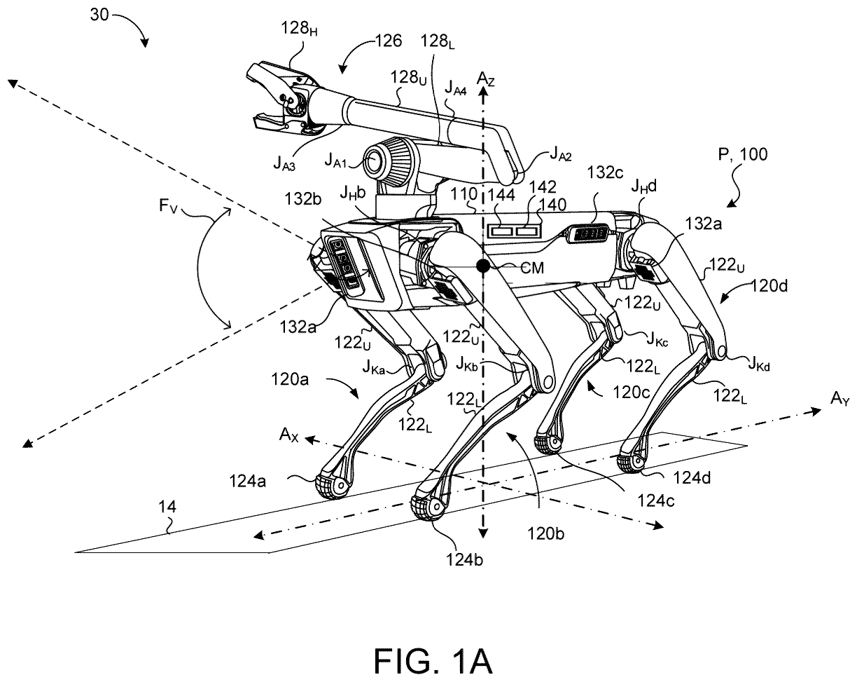

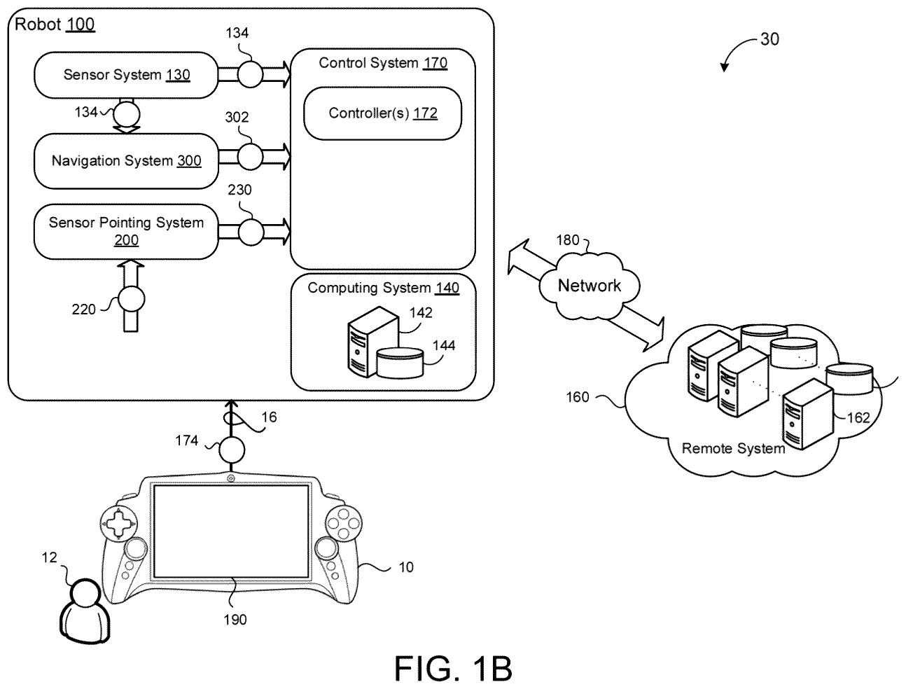

FIG. 1A is a schematic view of a robot 100 for navigating an environment 30. The robot 100 may include a body 110 with one or more locomotion-based structures such as a first leg 120a, a second leg 120b, a third leg 120c, and a fourth leg 120d coupled to the body 110 and that enable the robot 100 to move within the environment 30. In some examples, each leg is an articulable structure such that one or more joints J permit members of the leg to move. For instance, each leg includes a hip joint JH (for example, J_{H}b and J_{H}d of FIG. 1A) coupling an upper member 122_{U} of the leg to the body 110 and a knee joint JK (for example, J_{Ka}, J_{Kb}, J_{Kc}, and J_{Kd} of FIG. 1A) coupling the upper member 122_{U} of the leg to a lower member 122_{L} of the leg. Although FIG. 1A depicts a quadruped robot with four legs (e.g., the first leg 120a, the second leg 120b, the third leg 120c, and the fourth leg 120d), the robot 100 may include any number of legs or locomotive based structures (e.g., a biped or humanoid robot with two legs, or other arrangements of one or more legs) that provide a means to traverse the terrain within the environment 30.

In order to traverse the terrain, all or a portion of the first leg 120a, the second leg 120b, the third leg 120c, and/or the fourth leg 120d may have a distal end (for example, distal ends 124a, 124b, 124c, and 124d of FIG. 1A) that contacts a surface of the terrain (i.e., a traction surface). In other words, the distal end of each leg is the end of the leg used by the robot 100 to pivot, plant, or generally provide traction during movement of the robot 100. For example, the distal end of a leg corresponds to a foot of the robot 100. In some examples, though not shown, the distal end of the leg includes an ankle joint such that the distal end is articulable with respect to the lower member 122_{L} of the leg.

In the examples shown, the robot 100 includes an arm 126 (e.g., an articulated arm) that functions as a robotic manipulator. The arm 126 may move about multiple degrees of freedom in order to engage elements of the environment 30 (e.g., objects within the environment 30). In some examples, the arm 126 includes one or more members, where the members are coupled by joints J such that the arm 126 may pivot or rotate about the joint(s) J. For instance, with more than one member, the arm 126 may extend or to retract. To illustrate an example, FIG. 1A depicts the arm 126 with three members corresponding to a lower member 128_{L}, an upper member 128_{U}, and a hand member 128_{H} (e.g., also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is also coupled to the upper member 128_{U} at a second arm joint J_{A2}, while the upper member 128_{U} is coupled to the hand member 128_{H} at a third arm joint J_{A3}.

In some examples, such as in FIG. 1A, the hand member 128_{H} is a mechanical gripper that includes a moveable jaw and a fixed jaw may perform different types of grasping of elements within the environment 30. In the example shown, the hand member 128_{H} includes a fixed first jaw and a moveable second jaw that grasps objects by clamping the object between the jaws. The moveable jaw may move relative to the fixed jaw to move between an open position for the gripper and a closed position for the gripper (e.g., closed around an object).

In some implementations, the arm 126 additionally includes a fourth joint J_{A4}. The fourth joint J_{A4} may be located near the coupling of the lower member 128_{L} to the upper member 128_{U} and functions to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket may be a connector such that the arm 126 attaches or detaches from the robot 100 depending on whether the arm 126 is needed for operation.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (i.e., a point where the weighted relative position of the distributed mass of the robot 100 sums to zero). The robot 100 further has a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the first leg 120a, the second leg 120b, the third leg 120c, and the fourth leg 120d relative to the body 110 may alter the pose P of the robot 100 (i.e., the combination of the position of the CM of the robot and the attitude or orientation of the robot 100). Here, a height generally refers to a distance along the z-direction (e.g., along the z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 and the distal ends 124a, 124b, 124c, 124d may generate traction at the ground surface 14 to help the robot 100 move within the environment 30. Another anatomical plane of the robot 100 is the frontal plane that extends across the body 110 of the robot 100 (e.g., from a left side of the robot 100 with the first leg 120a to a right side of the robot 100 with the second leg 120b). The frontal plane spans the X-Z plane by extending in directions of the x-direction axis A_{X} and the z-direction axis A_{z}.

In order to maneuver about the environment 30 or to perform tasks using the arm 126, the robot 100 includes a sensor system with one or more sensors. For example, FIG. 1A illustrates a first sensor 132a mounted at a front of the robot 100 (near a front portion of the robot 100 adjacent the front legs (e.g., the first leg 120a and the second leg 120b)), a second sensor 132b mounted near the hip of the second leg 120b of the robot 100, a third sensor 132c corresponding to one of the sensors mounted on a side of the body 110 of the robot 100, a fourth sensor 132d mounted near the hip of the fourth leg 120d of the robot 100, and a fifth sensor 132e mounted at or near the hand member 128_{H} of the arm 126 of the robot 100. The sensors may include vision/image sensors, inertial sensors (e.g., an inertial measurement unit (IMU)), force sensors, and/or kinematic sensors. Some examples of sensors include a camera such as a stereo camera a visual red-green-blue (RGB) camera, or a thermal camera, a time-of-flight (TOF) sensor, a scanning light-detection and ranging (LIDAR) sensor, or a scanning laser-detection and ranging (LADAR) sensor. Other examples of sensors include microphones, radiation sensors, and chemical or gas sensors.

In some examples, the sensor has a corresponding field(s) of view F_{V} defining a sensing range or region corresponding to the sensor. For instance, FIG. 1A depicts a field of a view F_{V} for the robot 100. Each sensor may be pivotable and/or rotatable such that the sensor, for example, changes the field of view F_{V} about one or more axis (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With sensors placed about the robot 100, the sensor system may have a 360 degree view or a nearly 360 degree view (with respect to the X-Y or transverse plane) of the surroundings of the robot 100.

When surveying a field of view F_{V} with a sensor, the sensor system generates sensor data 134 (e.g., image data) corresponding to the field of view F_{V}. The sensor system may generate the field of view F_{V} with a sensor mounted on or near the body 110 of the robot 100 (e.g., the first sensor 132a, the second sensor 132b, etc.). The sensor system may additionally and/or alternatively generate the field of view F_{V} with a sensor mounted at or near the hand member 128_{H} of the arm 126 (e.g., the fifth sensor 132e). The one or more sensors capture the sensor data 134 that defines the three-dimensional point cloud for the area within the environment 30 of the robot 100. In some examples, the sensor data 134 is image data that corresponds to a three-dimensional volumetric point cloud generated by a three-dimensional volumetric image sensor. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data 134, various systems of the robot 100 may use the sensor data 134 to define a current state of the robot 100 (e.g., of the kinematics of the robot 100) and/or a current state of the environment 30 about the robot 100. In other words, the sensor system may communicate the sensor data 134 from one or more sensors to any other system of the robot 100 in order to assist the functionality of that system.

In some implementations, the sensor system includes sensor(s) coupled to a joint J. Moreover, these sensor(s) may couple to a motor M that operates a joint J of the robot 100 (e.g., the second sensor 132b, the third sensor 132c, the fourth sensor 132d, etc.). The sensor(s) may generate joint dynamics in the form of joint-based sensor data. Joint dynamics may include joint angles (e.g., an upper member 122_{U} relative to a lower member 122_{L} or hand member 128_{H} relative to another member of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor measures joint position (or a position of member(s) coupled at a joint J) and systems of the robot 100 perform further processing to derive velocity and/or acceleration from the positional data. In other examples, a sensor may measure velocity and/or acceleration directly.

As the sensor system gathers sensor data 134, a computing system 140 stores, processes, and/or to communicates the sensor data 134 to various systems of the robot 100 (e.g., the control system 170, a sensor pointing system 200, a navigation system 300, and/or remote controller 10, etc.). In order to perform computing tasks related to the sensor data 134, the computing system 140 of the robot 100 (which is schematically depicted in FIG. 1A and can be implemented in any suitable location(s), including internal to the robot 100) includes data processing hardware 142 and memory hardware 144. The data processing hardware 142 may execute instructions stored in the memory hardware 144 to perform computing tasks related to activities (e.g., movement and/or movement-based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg).

Additionally or alternatively, the computing system 140 can utilize computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 may utilize the remote data processing hardware 162 and the remote memory hardware 164 as extensions of the data processing hardware 142 and the memory hardware 144 such that resources of the computing system 140 reside on resources of the remote system 160.

FIG. 1B is a schematic view of one embodiment of a sensor pointing system 200 for pointing a sensor of the robot 100 of FIG. 1A. The robot 100 may include a control system 170. The control system 170 may communicate with systems of the robot 100, such as the sensor system 130, the navigation system 300 (e.g., with navigation commands 302), and/or the sensor pointing system 200 (e.g., with body pose commands 230). The control system 170 may perform operations and other functions using the computing system 140. The control system 170 includes at least one controller 172 that may control the robot 100. For example, the at least one controller 172 controls movement of the robot 100 to traverse about the environment 30 based on input or feedback from the systems of the robot 100 (e.g., the sensor system 130 and/or the control system 170). In additional examples, the at least one controller 172 controls movement between poses and/or behaviors of the robot 100. The at least one controller 172 may be responsible for controlling movement of the arm 126 of the robot 100 in order for the arm 126 to perform various tasks using the hand member 128_{H}. For instance, the at least one controller 172 controls the hand member 128_{H} (e.g., a gripper) to manipulate an object or element in the environment 30. For example, the at least one controller 172 actuates the movable jaw in a direction towards the fixed jaw to close the gripper. In other examples, the at least one controller 172 actuates the movable jaw in a direction away from the fixed jaw to close the gripper.

The at least one controller 172 (e.g., a programmable controller) may control the robot 100 by controlling movement about one or more joints J of the robot 100. In some configurations, the at least one controller 172 may be software or firmware with programming logic that controls at least one joint J and/or a motor M which operates, or is coupled to, a joint J. A software application (i.e., a software resource) may refer to computer software that causes a computing device to perform a task. In some examples, a software application may be referred to as an “application,” an “app,” or a “program.” For instance, the at least one controller 172 may control an amount of force that is applied to a joint J (e.g., torque at a joint J). As the at least one controller 172 may be programmable, the number of joints J that the at least one controller 172 may control may be scalable and/or customizable for a particular control purpose. The at least one controller 172 may control a single joint J (e.g., control a torque at a single joint J), multiple joints J, or actuation of one or more members (e.g., actuation of the hand member 128_{H}) of the robot 100. By controlling one or more joints J, actuators, or motors M, the at least one controller 172 may coordinate movement for all different parts of the robot 100 (e.g., the body 110, the arm 126, and one or more of the first leg 120a, the second leg 120b, the third leg 120c, and the fourth leg 120d). For example, to perform a behavior with some movements, the at least one controller 172 may control movement of multiple parts of the robot 100 such as, for example, two legs (e.g., the first leg 120a and the second leg 120b), four legs (e.g., the first leg 120a, the second leg 120b, the third leg 120c, and the fourth leg 120d), or two legs (e.g., the first leg 120a and the second leg 120b) combined with the arm 126. In some examples, the at least one controller 172 may be an object-based controller that is setup to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 may display the image that corresponds to three-dimensional field of view Fv of the one or more sensors. The image displayed on the user interface 190 of the remote controller 10 is a two-dimensional image that corresponds to the three-dimensional point cloud of sensor data 134 (e.g., field of view Fv) for the area within the environment 30 of the robot 100. That is, the image displayed on the user interface 190 may be a two-dimensional image representation that corresponds to the three-dimensional field of view Fv of the one or more sensors.

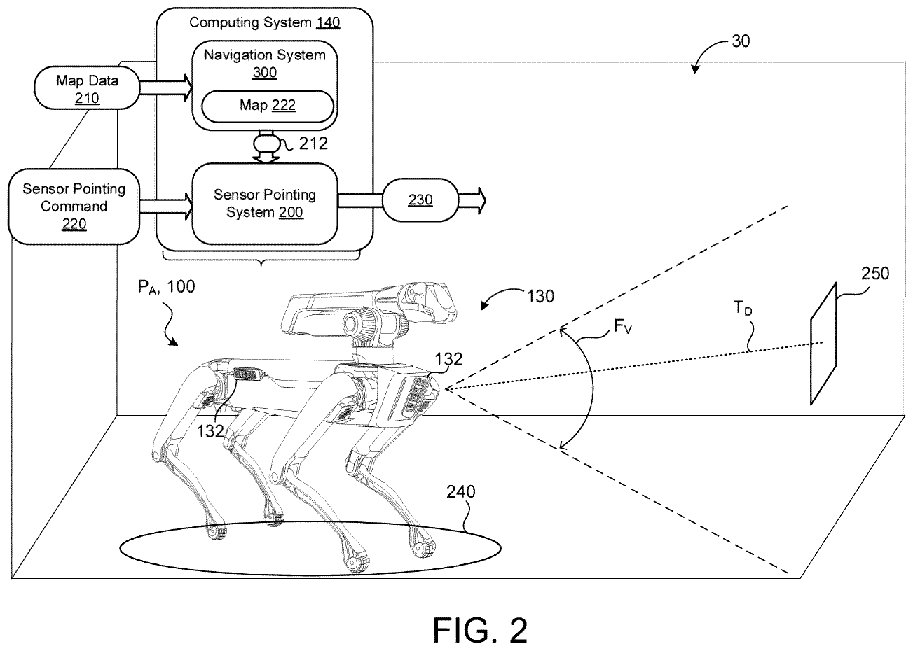

In some implementations, as shown in FIG. 2, the robot 100 is located in the environment 30 and is equipped with the sensor system 130 that includes one or more sensors 132 (disposed on the body 110, in this example) on the robot 100 and having a field of view F_{V} that includes at least a portion of the environment 30 surrounding the robot 100. The computing system 140 of the robot 100 is equipped with data processing hardware and memory hardware with the memory hardware including instructions to be executed by the data processing hardware. The computing system 140 can operate the navigation system 300 and the sensor pointing system 200 (for instance, in autonomous inspection applications) to navigate the robot 100 to a POI and use the one or more sensors 132 to capture sensor data 134 at the POI in a particular way all without user input or supervision.

In the illustrated embodiment, the computing system 140 includes the navigation system 300 that generates or receives a map 222 (e.g., a navigation map, a graph map, etc.) from map data 210 obtained by the computing system 140. The navigation system 300 generates a navigation route 212 (e.g., a route, a route path, etc.) that plots a path around large and/or static obstacles from a start location (e.g., the current location of the robot 100) to a destination. The navigation system 300 is in communication with the sensor pointing system 200. The sensor pointing system 200 may receive the navigation route 212 or other data from the navigation system 300 in addition to sensor data 134 from the sensor system 130.

The sensor pointing system 200 receives a sensor pointing command 220 (e.g., from the user 12) that directs the robot 100 to capture sensor data 134 of a target location 250 (e.g., a specific area or a specific object in a specific area) and/or in a target direction T_{D}. The sensor pointing command 220 may include one or more of the target location 250, the target direction T_{D}, an identification of the one or more sensors 132 to capture sensor data 134 with, etc. When the robot is proximate the target location, the sensor pointing system 200 generates one or more body pose commands 230 (e.g., to the control system 170) to position the one or more sensors 132 such that the target location 250 and/or the target direction T_{D} are within the field of sensing of the one or more sensors 132. For example, the sensor pointing system 200 determines necessary movements of the one or more sensors 132 and/or of the robot 100 (i.e., adjust a position or orientation or pose P of the robot) to align the field of sensing of the one or more sensors 132 with the target location 250 and/or target direction T_{D}.

In some examples, and as discussed in more detail below, the sensor pointing system 200 directs the pose P of the robot 100 to compensate for a sensed error in the one or more sensors 132 configuration or orientation. For example, the robot 100 may alter its current pose P to accommodate a limited range of motion of the field of view F_{V} of the sensor, avoid occluding the captured sensor data, or match a desired perspective of the target location 250. Thus, in some implementations, the sensor pointing system 200, based on an orientation of the one or more sensors 132 relative to the target location 250, determines the target direction T_{D} to point the one or more sensors 132 toward the target location 250.

Alternatively or additionally, the sensor pointing system determines an alignment pose P_{A} of the robot to cause the one or more sensors 132 to point in the target direction T_{D} toward the target location 250. The sensor pointing system 200 may command the robot 100 to move to the alignment pose P_{A} to cause the one or more sensors 132 to point in the target direction T_{D}. After the robot 100 moves to the alignment pose P_{A}, and with the one or more sensors 132 pointing in the target direction T_{D} toward the target location 250, the sensor pointing system 200 may command the one or more sensors 132 to capture sensor data 134 of the target location 250 in the environment 30.

In other words, the computing system 140 may receive the sensor pointing command 220 (e.g., from the user 12) that, when implemented, commands the robot 100 to capture sensor data 134 using the one or more sensors 132 disposed on the robot 100. Based on the orientation of the one or more sensors 132 relative to the target location 250, the sensor pointing system 200 determines the target direction T_{D} and the alignment pose P of the robot 100. The determined target direction T_{D} points the one or more sensors 132 toward the target location 250 and the determined alignment pose P_{A} of the robot 100 causes the one or more sensors 132 to point in the target direction T_{D} toward the target location 250. The sensor pointing system 200 may command the robot 100 to move from a current pose P of the robot 100 to the alignment pose P_{A} of the robot. After the robot 100 moves to the alignment pose P_{A} and with the one or more sensors 132 pointing in the target direction T_{D} toward the target location 250, the sensor pointing system 200 commands the one or more sensors 132 to capture sensor data 134 of the target location 250 in the environment 30.

As will become apparent from this disclosure, the sensor pointing system 200, along with other features and elements of the methods and systems disclosed herein, make the data capture of target locations 250 in environments 30 repeatable and accurate as the robot 100 is sensitive to sensed and unsensed error in the robot's position, orientation, and sensor configuration. The sensor pointing system 200 allows the robot 100 to overcome odometry and sensor error when capturing sensor data 134 relative to the target location 250 at least in part by determining the target direction T_{D} for pointing the one or more sensors 132 at the target location 250 and the alignment pose P_{A} for achieving the target direction T_{D} based on the orientation of the one or more sensors 132 relative to the target location 250.

In some examples, in response to receiving the sensor pointing command 220, the sensor pointing system 200 commands the robot 100 to navigate to a target point of interest 240 (target POI) within the environment 30. In such examples, the sensor pointing system 200 determines the target direction T_{D} and the alignment pose P_{A} of the robot 100 after the robot 100 navigates to the target point of interest 240.

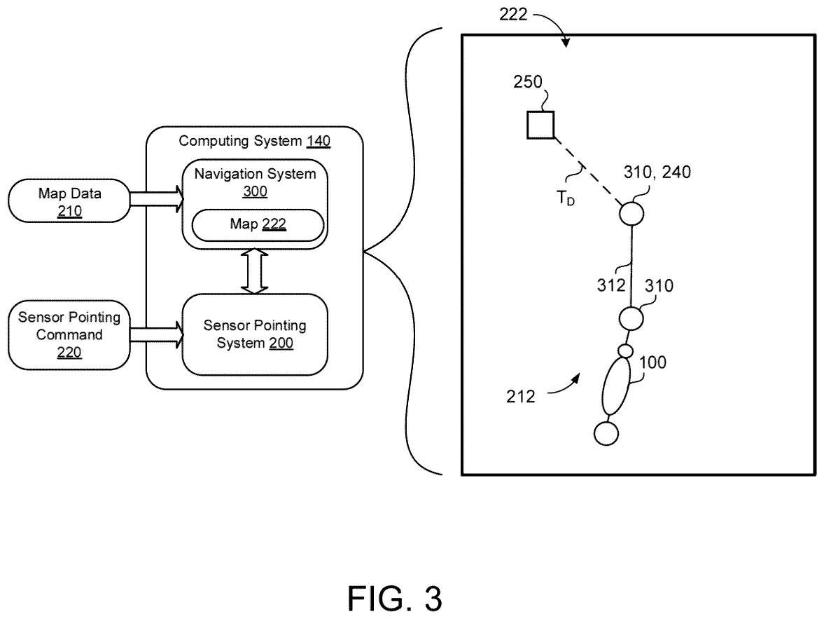

Referring now to FIG. 3, in some examples, the navigation system 300 (e.g., based on map data 210, sensor data 134, etc.) can generate one or more route waypoints 310 on the map 222 for the navigation route 212 that plots a path around large and/or static obstacles from a start location (e.g., the current location of the robot 100) to a destination (e.g., the target point of interest 240). One or more route edges 312 connect corresponding pairs of adjacent route waypoints of the one or more route waypoints 310. The robot 100, when navigating the environment 30, travels from a first route waypoint of the one or more route waypoints 310 to a second route waypoint of the one or more route waypoints 310 by traversing along the one or more route edges 312. In some examples, the target point of interest 240 is a route waypoint of the one or more route waypoints 310 on the map 222. In the example shown, the robot 100 travels along the navigation route 212 until reaching the target point of interest 240 (i.e., a specified route waypoint of the one or more route waypoints 310). In some examples, the target point of interest 240 is the final route waypoint of the one or more route waypoints 310 along the navigation route 212, while in other examples, the navigation route 212 continues on with additional route waypoints of the one or more route waypoints 310 and route edges 320 for the robot 100 to continue along after capturing the sensor data 134 at the target point of interest 240 and the navigation route 212 may include any number of target points of interest for capturing sensor data 134 at various locations along the navigation route 212.

Thus, based on guidance provided by the navigation system 300, the robot 100 arrives at a route waypoint of the one or more route waypoints 310 defined by the target point of interest 240. After arrival at the waypoint, the sensor pointing system 200 may determine an orientation of the sensor relative to the target location 250. Based on the orientation of the sensor relative to the target location 250, the sensor pointing system 200 determines the target direction T_{D} for pointing the sensor toward the target location 250.

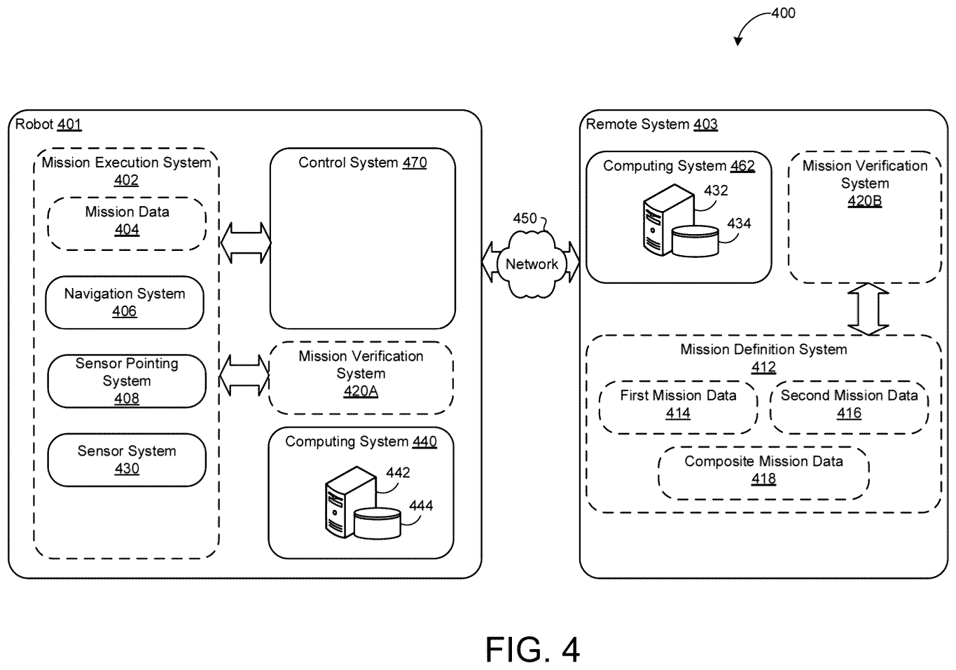

Although examples herein (e.g., FIG. 2) illustrate the sensor integrated into the body of the robot 100 at a front portion of the robot 100 with a field of view F_{V} primarily forward of the robot, the sensor (or sensors) may be disposed in any suitable manner on the robot 100. The sensor may include any number of different types of sensors such as a camera, LIDAR, and/or microphone. For example, the sensor may be built into the body 110 of the robot 100 or attached as a payload. In some examples, the sensor is disposed on the arm 126. Additionally, the sensor may be permanently fixed to the robot 100 as part of its original manufacture or alternatively disposed or mounted at the robot 100 (e.g., client hardware) and connected to the sensor pointing system 200 via client software (FIG. 4). The sensor may have any fixed or pivotable (e.g., a pan-tilt-zoom (PTZ) sensor such as a PTZ camera) field of view/field of sensing. Because the orientation of the sensor is based at least in part on the pose P of the robot 100, movement of the robot 100, such as to the alignment pose P_{A}, changes the field of view of the sensor.

The target direction T_{D}, in some examples, is parameterized by the sensor pointing command 220. In other words, the sensor pointing command 220 may include instructions as to how the sensor data 134 of the target location 250 should be captured, such as from a certain direction, angle, zoom, focus, and/or distance relative to the target location 250 or with the target location 250 framed a certain way in the field of view F_{V} of the sensor. Thus, the sensor pointing command 220 may include parameters for capturing sensor data 134 of the target location 250, such as angle, height, proximity, and direction of the sensor relative to the target location, and parameters related to placement of the target location 250 within the sensor data 134. The parameters may also include configuration for the sensor while capturing the sensor data 134 (e.g., zoom, focus, exposure, control of illumination sources, etc.). The sensor pointing system 200 may determine the target direction T_{D} based on the parameters of the sensor pointing command 220. Alternatively, the target direction T_{D} may be provided by the sensor pointing command 220. Based on the parameters of the sensor pointing command 220 and/or the target direction TD, the sensor pointing system 200 commands the robot 100 (e.g., to the alignment pose P_{A}) and/or sensor to move to orient the sensor toward the target location 250.

FIG. 4 is a schematic view 400 of a robot 401 in communication with a remote system 403. The robot 401 may be similar to and/or may incorporate features of the robot 100 discussed above with respect to FIG. 1A and FIG. 1B. In some cases, the robot 401 may include a set of robots. For example, a set of robots may be in communication with the remote system 403. Further, the remote system 403 may be similar to and/or may incorporate features of the remote system 160 discussed above with respect to FIG. 1B.

As discussed above and shown in FIG. 4, the robot 401 includes a sensor system 430 (similar to or including the sensor system 130 as discussed above with respect to FIG. 1B), a control system 470 (similar to or including the control system 170 as discussed above with respect to FIG. 1B), a navigation system 406 (similar to or including the navigation system 300 as discussed above with respect to FIG. 3), a sensor pointing system 408 (similar to or including the sensor pointing system 200 as discussed above with respect to FIG. 2 and FIG. 3), and a computing system 440 (similar to or including the computing system 140 as discussed above with respect to FIG. 1B).

Further, the remote system 403 includes a computing system 462. The computing system 462 includes data processing hardware 432 (similar to or including the remote data processing hardware 162 as discussed above with respect to FIG. 1B) and memory hardware 434. The data processing hardware 432 may execute instructions stored in the memory hardware 434 to perform computing tasks related to activities (e.g., implementation of a mission definition system) for the robot 401. The computing system 462 may be one or more locations of data processing hardware 432 and/or memory hardware 434.

The remote system 403 and the robot 401 may be in communication via a network 450 (similar to or including the network 180 as discussed above with respect to FIG. 1B). For example, the network 450 may be a local area network, a wide area network, etc.

All or a portion of the robot 401 and the remote system 403 may include a mission definition system (e.g., a mission generation system), a mission verification system, and/or a mission execution system. For example, as shown in FIG. 4, the robot 401 includes a mission execution system 402 and a mission verification system 420A and the remote system 403 includes a mission definition system 412 and a mission verification system 420B. In some cases, one or more of the robot 401 or the remote system 403 may not include a mission verification system. For example, the robot 401 may include the mission verification system 420A and the remote system 403 may not include the mission verification system 420B.

In some cases, the mission definition system 412 and/or the mission verification system 420B may be or may be implemented by the computing system 462 and/or the mission execution system 402 and/or the mission verification system 420A may be or may be implemented by the computing system 440.

In some cases, the remote system 403 may include the mission execution system 402 and/or the robot 401 may include the mission definition system 412. For example, in some cases, the robot 401 may define and execute a mission at the robot 401 (and verify the mission or corresponding mission data).

In the example of FIG. 4, the mission definition system 412 includes first mission data 414, second mission data 416, and composite mission data 418. The mission definition system 412, via the computing system 462, may obtain mission data from one or more data sources (e.g., robots, user computing devices, a data store, etc.). For example, the mission definition system 412 may obtain the first mission data 414 based on a mission recording process executed by a first robot (e.g., executing and recording a mission corresponding to the first mission data 414) and may obtain the second mission data 416 based on a mission recording process executed by a second robot (e.g., executing and recording a mission corresponding to the second mission data).

In the example of FIG. 4, the robot 401 may implement a mission recording process, generate mission data 404 based on the mission recording process, and provide the mission data 404 to the remote system 403. The remote system 403 may store the mission data 404 as first mission data 414 or second mission data 416 (e.g., in memory hardware 434). In some cases, the robot 401 may store the mission data 404 in local data storage (e.g., in memory hardware 444).

In some cases, the mission definition system 412 may obtain mission data based on a set of mission recording processes executed by the same robot (e.g., a robot can execute and record a first mission corresponding to the first mission data 414 and execute and record a second mission corresponding to the second mission data 416).

In another example, the mission definition system 412 may obtain mission data (e.g., a selection of mission data) via a user interface (e.g., as input from a user computing device via the user interface). The mission data may indicate a selection of all or a portion of mission data defining a mission by a robot and/or user-defined data. For example, the mission data may indicate one or more parameters (e.g., one or more mission parameters, one or more mission characteristics, one or more mission factors, one or more mission constraints, etc.) For example, the one or more parameters may include one or more route waypoints, one or more route edges, one or more actions, etc. In another example, the one or more parameters indicate a user-defined route waypoint, a user-defined route edge, and/or a user-defined action.

It will be understood that while FIG. 4 illustrates the mission definition system 412 as including first mission data 414 and second mission data 416, the mission definition system 412 can include any amount of mission data corresponding to any number of missions executed by any number of robots. For example, the mission definition system 412 may include mission data corresponding to a set of missions executed by a set of robots.

In some cases, the parameters of the first mission data 414 and the second mission data 416 may identify a route through an environment (e.g., the parameters of the first mission data 414 and the second mission data 416 may include route data). For example, the first mission data 414 and the second mission data 416 may include one or more route waypoints and one or more route edges in the environment indicating a route of a robot through the environment.

In some cases, the parameters of the first mission data 414 and the second mission data 416 may identify one or more actions (e.g., associated with the route) for the same route waypoints or different route waypoints. For example, the first mission data 414 may indicate that a first route waypoint is associated with a first action and a second route waypoint is associated with a second action, while the second mission data 416 may indicate that the first route waypoint is associated with a third action (different from the first action), the second route waypoint is not associated with an action, a fourth route waypoint is associated with a fourth action, and a fifth route waypoint is associated with the second action.

The one or more actions may include actions to actuate or implement all or a portion of the robot 401, a component of the robot 401, a component separate from the robot 401, etc. For example, the one or more actions may include actions to actuate an appendage (e.g., an arm, a leg, etc.) of the robot 401, a sensor (e.g., an image sensor, a lidar sensor, etc.) of the robot 401 or separate from the robot 401, an output device (e.g., a speaker, a user interface, a display, etc.), etc. In another example, the one or more actions may include actions to navigate within the environment (e.g., to navigate to a particular route waypoint within the environment).

Based on the first mission data 414 and the second mission data 416, the mission definition system 412 can define a composite mission. For example, the mission definition system 412 can generate composite mission data 418 defining (e.g., indicating how to perform) the composite mission. The mission definition system 412 may determine how to generate the composite mission data 418 (e.g., based on a user input). For example, the mission definition system 412 may determine how to process (e.g., filter, merge, etc.) the first mission data 414 and the second mission data 416 to generate the composite mission data 418.

In some cases, to define the composite mission, the mission definition system 412 may identify at least a portion of the first mission data 414 to merge with at least a portion of the second mission data 416. The mission definition system 412 may identify the at least a portion of the first mission data 414 and the at least a portion of the second mission data 416 based on an input (e.g., received via a user interface). For example, the mission definition system 412 can cause display of all or a portion of the first mission data 414 and/or all or a portion of the second mission data 416 (or a pictorial representation of the first mission data 414 and/or the second mission data 416). The mission definition system 412 may obtain an input via the user interface indicating a selection (e.g., a user-defined selection) of at least a portion of the first mission data 414 and the at least a portion of the second mission data 416 to be merged to generate the composite mission data 418. For example, the input may indicate a selection of one or more mission agnostic actions to define the composite mission.

In some cases, to define the composite mission, the mission definition system 412 may not merge at least a portion of the first mission data 414 with at least a portion of the second mission data 416 and instead, the mission definition system 412 may generate the composite mission data 418 based on a portion of the first mission data 414 or the second mission data 416. For example, the mission definition system 412 may filter the first mission data 414 and/or the second mission data 416 to generate the composite mission data 418. In another example, the composite mission data 418 may include a first portion of the first mission data 414 and exclude a second portion of the first mission data 414. In some cases, an input may indicate a portion of the mission data (e.g., to include or exclude) for the composite mission data 418. In some cases, the second mission data 416 may indicate a portion of the first mission data 414 (e.g., to include or exclude) for the composite mission data 418.

Based on defining the composite mission, the mission definition system 412 can generate the composite mission data 418 and store the composite mission data 418. As discussed above, as the mission definition system 412 may generate the composite mission data 418 based on the first mission data 414 and the second mission data 416, the composite mission may not correspond to a mission recorded (e.g., previously) by the robot 401. Instead, the composite mission may correspond to at least a portion of one or more missions previously recorded by one or more robots. In some cases, the composite mission may correspond to one or more missions recorded by a first robot and the remote system 403 may instruct execution of the mission by a second robot that did not previously record the composite mission and/or the one or more missions.

The mission definition system 412 may provide the composite mission data 418 to the mission verification system 420B for verification of the composite mission, the composite mission data 418, and/or the characteristics of the robot 401. In some cases, the mission definition system 412 may not provide the composite mission data 418 to the mission verification system 420B. For example, the remote system 403 may not include the mission verification system 420B and the computing system 462 may provide the composite mission data 418 to the robot 401, via the network 450, for verification using the mission verification system 420A as implemented by the computing system 440. In some cases, the mission verification system 420A and/or the mission verification system 420B may or may not verify the composite mission, the composite mission data 418, and/or the characteristics of the robot 401.

To verify the composite mission, the composite mission data 418, and/or the characteristics of the robot 401, the mission verification system 420A and/or the mission verification system 420B may obtain an input (e.g., via a user interface). The input may indicate a selection of mission data for generation of the composite mission data 418 (e.g., one or more parameters) and/or a robot (e.g., robot 401) for execution of a corresponding composite mission. In some cases, the input may indicate one or more characteristics of the robot. Based on the input, the mission verification system 420A and/or the mission verification system 420B may identify the robot 401 and the composite mission data 418.

The mission verification system 420A and/or the mission verification system 420B may identify one or more characteristics of the robot 401 based on the input. For example, the one or more characteristics of the robot 401 may include a number (e.g., two, four, six, etc.), a type (e.g., an arm, a lidar sensor, etc.), a status (e.g., active, inactive, working, occupied, etc.), a location (e.g., at a top portion of the robot 401 relative to a ground surface of the environment), etc. of sensors, appendages, memory, processing units, etc. In another example, the one or more characteristics of the robot 401 may include a processing power, processing speed, processing capabilities, sensing power, sensing speed, sensing capabilities, etc. associated with the robot 401 (e.g., 100 million instructions per second processing power, point cloud sensing capabilities, 1 gigahertz processing speed or sensing speed, etc.).

In some cases, the one or more characteristics of the robot 401 may be stored in memory hardware 444 and/or memory hardware 434. For example, the mission verification system 420A and/or the mission verification system 420B may obtain the one or more characteristics from the memory hardware 444 and/or the memory hardware 434.

In some cases, the mission verification system 420A and/or the mission verification system 420B may identify the one or more characteristics of the robot 401 based on providing a prompt to the computing system 440 and/or the computing system 462 to define the one or more characteristics of the robot 401 and obtaining a response from the computing system 440 and/or the computing system 462. For example, the mission verification system 420A and/or the mission verification system 420B may request one or more characteristics of the robot 401 (e.g., indicating whether the robot 401 includes a lidar sensor) based on the one or more parameters (e.g., indicating the composite mission data includes an action to obtain point cloud data).

The mission verification system 420A and/or the mission verification system 420B may prompt the computing system 440 and/or the computing system 462 and, in response to the prompt, the computing system 440 and/or the computing system 462 may communicate with the robot 401 to determine the one or more characteristics of the robot 401. For example, the computing system 440 and/or the computing system 462 may communicate directly and/or indirectly with a sensor, a port, etc. of the robot 401 to determine the one or more characteristics (e.g., a type of sensor, a status of the sensor, etc.). In another example, the computing system 440 and/or the computing system 462 may communicate a test message (e.g., requesting a response) to determine a status of a device. In another example, the computing system 440 and/or the computing system 462 may process an output (e.g., an output of a sensor, an output of a device, etc.) to determine the one or more characteristics.

In some cases, the mission verification system 420A and/or the mission verification system 420B may obtain an input (e.g., directly or indirectly) from a computing device and define the one or more characteristics of the robot 401 based on the input. For example, the mission verification system 420A and/or the mission verification system 420B may obtain input from an image sensor, the input including image data indicative of the image data, and may define one or more characteristics of the robot 401 based on the input (e.g., the robot 401 includes an arm, the robot 401 includes a lidar sensor, etc.).

In some cases, the mission verification system 420A and/or the mission verification system 420B may perform a web crawl and/or may obtain an input based on performance of a web crawl to identify characteristics of the robot 401 (e.g., based on a model number of the robot 401, based on a news article, etc.). For example, the mission verification system 420A and/or the mission verification system 420B may identify a model number of the robot 401, perform a web crawl to identify data associated with the robot 401 based on the model number (e.g., a specification sheet, a news article, etc.) and identify the characteristics of the robot 401.

In some cases, the mission verification system 420A and/or the mission verification system 420B may obtain the one or more characteristics (e.g., via a user interface) as part of a setup process of the robot 401. For example, the mission verification system 420A and/or the mission verification system 420B may obtain the one or more characteristics from a computing device that is setting up the robot 401.

To verify the composite mission data 418 and/or the robot 401, the mission verification system 420A and/or the mission verification system 420B may compare the one or more characteristics to the parameters of the composite mission data 418. For example, the mission verification system 420A and/or the mission verification system 420B may verify whether the robot 401 can perform the composite mission (e.g., is capable of performing the composite mission, is free to perform the composite mission, is not occupied executing another mission, is not scheduled to perform another mission within a particular time period, can perform the composite mission within a particular time period, can initialize execution of the composite mission within a particular time period, can perform the composite mission within a particular accuracy, is permitted to perform the composite mission, etc.) based on one or more parameters of the composite mission data 418 (e.g., indicating one or more actions such as capturing lidar data, traversing one or more stairs, providing an audio output, etc.) and the one or more characteristics (e.g., whether the robot 401 has an active, working lidar sensor, whether the robot 401 is capable of traversing stairs, whether the robot 401 has an audio output device, whether the robot 401 has the processing and/or sensing capabilities to perform the set of actions, etc.).

In some cases, the mission verification system 420A and/or the mission verification system 420B may verify the composite mission data 418 and/or the robot 401 (e.g., may determine that the robot 401 can execute the composite mission) and may provide the composite mission data 418 to the mission execution system 402.

In some cases, the mission verification system 420A and/or the mission verification system 420B may not verify the composite mission data 418 and/or the robot 401 (e.g., may determine that the robot 401 cannot execute at least a portion of the composite mission). For example, the mission verification system 420A and/or the mission verification system 420B may determine that the one or more parameters indicate an action to capture point cloud data and the one or more characteristics indicate that the robot 401 does not include a lidar sensor.

In response to not verifying the composite mission data 418 and/or the robot 401 (e.g., determining that the robot 401 cannot execute at least a portion of the composite mission), the mission verification system 420A and/or the mission verification system 420B (or a separate system) may filter the composite mission data 418 to exclude portions of the composite mission data (and/or the composite mission) that are not verified and may provide the filtered composite mission data (and/or the filtered composite mission) to the mission execution system 402.

In some cases, in response to not verifying the composite mission data 418 and/or the robot 401 (e.g., determining that the robot 401 cannot execute at least a portion of the composite mission), the mission verification system 420A and/or the mission verification system 420B (or a separate system) may provide an output indicating that the composite mission data 418 and/or the robot 401 was not verified. For example, the mission verification system 420A and/or the mission verification system 420B may instruct display of a user interface indicating that the composite mission data 418 and/or the robot 401 was not verified. In some cases, the mission verification system 420A and/or the mission verification system 420B may not provide composite mission data 418 that is not verified (e.g., whole or in part) to the mission execution system 402.

In some cases, in response to not verifying the composite mission data 418 and/or the robot 401 (e.g., determining that the robot 401 is not capable of executing at least a portion of the composite mission), the mission verification system 420A and/or the mission verification system 420B (or a separate system) may dynamically update the composite mission data 418. The mission verification system 420A and/or the mission verification system 420B may dynamically update the composite mission data 418 to remove a portion of the composite mission data 418 that was not verified and add mission data to the composite mission data 418 that is verified. For example, the mission verification system 420A and/or the mission verification system 420B may dynamically update the composite mission data 418 to remove a portion of the composite mission data 418 corresponding to an action to capture point cloud data based on determining that the robot 401 does not include a lidar sensor and add mission data to the composite mission data 418 (or validate mission data within the composite mission data 418) corresponding to an action to capture image data based on determining that the robot 401 does include an image sensor. The mission verification system 420A and/or the mission verification system 420B may provide the dynamically updated composite mission data to the mission execution system 402.

In some cases, to verify the composite mission data 418 and/or the robot 401, the mission verification system 420A and/or the mission verification system 420B may utilize a neural network trained to verify the composite mission data 418 and/or the robot 401 (e.g., to determine whether the robot 401 can execute a mission, can execute a mission within a particular time period, can execute a mission within a particular threshold accuracy, etc.). The mission verification system 420A and/or the mission verification system 420B may verify the composite mission data 418 and/or the robot 410 (or determine that the composite mission data 418 and/or the robot 401 are not verified) based on the output of the neural network.

The mission execution system 402 may obtain the verified composite mission data from the mission verification system 420A and/or the mission verification system 420B. In some cases, the mission execution system 402 may obtain unverified composite mission data. In some cases, the mission execution system 402 may store the verified composite mission data in a data store (e.g., memory hardware 444)

To instruct execution of the composite mission, the mission execution system 402 may parse the verified composite mission data. For example, the mission execution system 402 may parse the verified composite mission data to identify route data (e.g., one or more route waypoints, one or more route edges, etc.) and one or more actions. Based on parsing the verified composite mission data, the mission execution system 402 may build a hierarchical set of actions (e.g., an execution graph or tree) identifying one or more actions for the robot 401 to perform, a component of the robot 401 used to perform the one or more actions, a location at which to perform the one or more actions (e.g., relative to a map), and an order of executing the one or more actions (e.g., a time at which to execute the one or more actions). For example, the hierarchical set of actions may indicate that the robot 401 is to navigate to a first route waypoint (e.g., a first location in an environment of the robot 401), perform a first action (e.g., obtain image data), navigate to a second route waypoint (e.g., a second location in an environment of the robot 401), etc.

Based on the hierarchical set of actions, the mission execution system 402 may identify one or more systems (e.g., the navigation system 406, the sensor pointing system 408, the sensor system 430, the control system 470, and/or the computing system 440) of the robot 401 to receive all or a portion of the hierarchical set of actions and route the actions to the identified systems. For example, the mission execution system 402 may identify a first action to navigate to a first route waypoint and may route a portion of the verified composite mission data to the navigation system 406 to instruct the robot 401 to navigate to the first route waypoint. In another example, the mission execution system 402 may identify a second action to capture point cloud data and may route a portion of the verified composite mission data to the sensor pointing system 408 and the sensor system 430 to instruct the robot 401 to capture the point cloud data.

In some cases, the mission execution system 402 may route timing instructions to the systems of the robot 401. For example, the mission execution system 402 may route timing instructions to the sensor system 430 that instruct the sensor system 430 to capture sensor data corresponding to a region of interest at a first route waypoint after the navigation system 406 causes the robot 401 to navigate to the first route waypoint and the sensor pointing system 408 validates that a corresponding sensor is directed to and/or causes direction of the corresponding sensor to the region of interest at the first route waypoint.

Based on identifying the one or more systems of the robot 401 and routing actions to the identified systems, the robot 401 may execute the composite mission. In some cases, based on the execution of the composite mission, the robot 401 may generate mission data (e.g., mission data 404) and may record (e.g., store) the mission data (e.g., in memory hardware 444). For example, while the robot 401 may not separately perform a mission recordation prior to execution of the composite mission, in some cases, the robot 401 may simultaneously perform the mission recordation and the mission execution. As discussed above, in some cases, the robot 401 may provide the mission data 404 to the remote system 403.

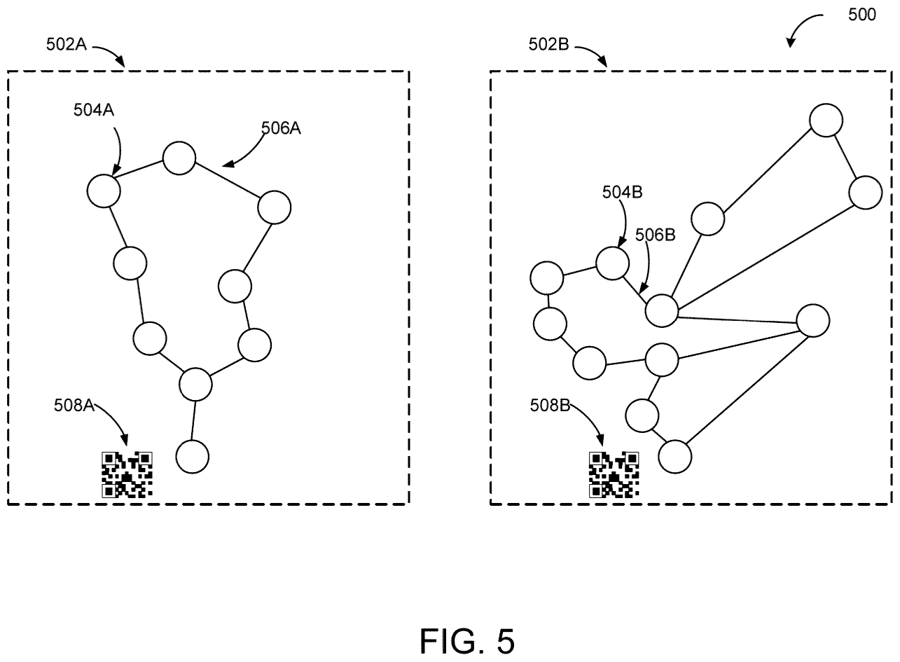

FIG. 5 is a schematic view 500 of exemplary route waypoints and route edges of a robot. The schematic view 500 includes a representation of a first mission 502A (e.g., a representation of first mission data) and a representation of a second mission 502B (e.g., a representation of second mission data). For example, the schematic view 500 may include a representation of the first mission 502A in a first parameter space and a representation of the second mission 502B in a second parameter space.

The first mission 502A and/or the second mission 502B may be based on (e.g., may represent) one or more missions by one or more robots through an environment (e.g., the same environment). For example, the first mission 502A may be based on a first mission by a first robot through the environment and the second mission 502B may be based on a second mission by a second robot through the environment. In another example, the first mission 502A may be based on a first mission by a robot through the environment and the second mission 502B may be based on a second mission by the robot through the environment.

One or more robots (e.g., data processing hardware of the one or more robots) may generate mission data corresponding to the first mission 502A and/or the second mission 502B based on execution of the first mission 502A and/or the second mission 502B. For example, the one or more robots may execute the first mission 502A and/or the second mission 502B, record the execution of the first mission 502A and/or the second mission 502B as mission data, and store the mission data.

The first mission 502A and/or the second mission 502B may be associated with one or more respective parameters (e.g., sensor data, route data, and/or one or more actions). The one or more respective parameters of the first mission 502A and/or the second mission 502B may be determined based on recordation and/or execution of the mission. In some cases, all or a portion of one or more route waypoints of the route data may be associated with a respective portion of sensor data and/or one or more actions. The first mission 502A and/or the second mission 502B may indicate a route by a robot through the environment, one or more actions performed by the robot (e.g., during traversal of the route), and/or sensor data used to localize within the environment.

The sensor data can include sensor data from one or more sensors of one or more robots. For example, the sensor data can include a first portion of the sensor data from a first sensor of a first robot, a second portion of the sensor data from a second sensor of the first robot, a third portion of the sensor data from a first sensor of a second robot, etc. In some embodiments, the sensor data may have different data types. For example, the sensor data may include point cloud data, image data, etc. In some cases, the sensor data can include sensor data from one or more sensors that are separate from the one or more robots (e.g., sensors of an external monitoring system).

In some embodiments, the sensor data may be associated with the route data (e.g., a navigation graph indicative of one or more route waypoints and one or more route edges). For example, all or a portion of one or more route waypoints (of the route data) may be linked to a portion of sensor data for localization by a robot.

All or a portion of the one or more route edges may topologically connect a particular route waypoint to a corresponding route waypoint. For example, a first route edge may connect the first route waypoint to a second route waypoint and a second route edge may connect the second route waypoint to a third route waypoint.

As discussed above, all or a portion of the route edges may represent a traversable route for the robot through the environment. For example, the traversable route may identify a route for the robot such that the robot can traverse the route without interacting with (e.g., running into, being within a particular threshold distance of, etc.) an obstacle, entity, structure, or object.

A system (e.g., a robot) can record the set of route waypoints and the set of route edges and sensor data associated with the particular route waypoint or route edge using the sensor data based on navigation of an environment by the robot. For example, the robot can record a route waypoint or route edge based on sensor data obtained by the robot that can include one or more of odometry data, point cloud data, fiducial data, orientation data, position data, height data (e.g., a ground plane estimate), time data, an identifier (e.g., a serial number of the robot, a serial number of a sensor, etc.), etc.

The robot can record the set of route waypoints at a set of locations in the environment. In some embodiments, the robot can record a route waypoint of the set of route waypoints based on execution of a particular maneuver (e.g., a turn), a determination that the robot is a threshold distance from a prior waypoint, etc. In some embodiments, the robot can record a route waypoint of the set of route waypoints at a predetermined location.

At all or a portion of the set of route waypoints, the robot may record a portion of the sensor data such that the respective route waypoint is associated with a respective set of sensor data captured by the robot (e.g., one or more point clouds). In some implementations, the route data includes information related to one or more fiducial markers.

In the example of FIG. 5, the first mission 502A is based on first mission data including a first set of route waypoints and a first set of route edges (including a first route waypoint 504A and a first route edge 506A) and the second mission 502B is based on second mission data including a second set of route waypoints and a second set of route edges (including a second route waypoint 504B and a second route edge 506B).

Missions may be associated with fiducial data (e.g., fiducial markers, quick-response codes, landmarks, identifiers, etc.). As shown in FIG. 5, the first mission 502A is associated with first fiducial data 508A and the second mission 502B are associated with second fiducial data 508B. The first fiducial data 508A and the second fiducial data 508B may be the same or different fiducial data.

To determine whether at least a portion of the first mission 502A and at least a portion of the second mission 502B are candidates for merging (e.g., can be merged) into a composite mission, the system may determine whether the first fiducial data 508A corresponds to (e.g., matches, is within a threshold range of similarity, matches or exceeds a threshold probability of being the same as) the second fiducial data 508B.

To determine whether the first fiducial data 508A corresponds to the second fiducial data 508B, the system may compare the first fiducial data 508A and the second fiducial data 508B to determine a comparison result. In some cases, the system may compare the first fiducial data 508A and the second fiducial data 508B by performing an image analysis or image processing operation, comparing an identifier associated with the first fiducial data 508A to an identifier associated with the second fiducial data 508B, comparing an environment, a room, a location, etc. indicated by the first fiducial data 508A to an environment, a room, a location, etc. indicated by the second fiducial data 508B, etc.

The comparison result may be a similarity (e.g., a similarity score), a probability that the first fiducial data 508A and the second fiducial data 508B are the same (e.g., based on the output of a neural network trained to determine whether fiducial data matches other fiducial data), etc. Based on comparing the first fiducial data 508A and the second fiducial data 508B, the system may compare the comparison result to a threshold (e.g., a threshold range, a threshold value, etc.).

If the system determines that the comparison result does not satisfy (e.g., is less than, matches, etc.) the threshold, the system may determine that the first mission 502A and the second mission 502B are not candidates for merging. Based on determining that the first mission 502A and the second mission 502B are not candidates for merging, the system may provide (e.g., a representation of) the first mission 502A (with or without one or more missions that the system determines are a candidate for merging with the first mission 502A, if any) and the second mission 502B (with or without one or more missions that the system determines are a candidate for merging with the second mission 502B, if any) for display individually (and separately) via one or more user interfaces.

Based on instructing display of the first mission 502A and the second mission 502B individually via one or more user interfaces, the system may receive input via the one or more user interfaces indicating at least a portion of the first mission 502A or at least a portion of the second mission 502B for definition of a composite mission. For example, the input may indicate a filter to apply to the first mission 502A to define the composite mission. By instructing display individually of the first mission 502A and the second mission 502B, while the system may enable selection of at least a portion of the first mission 502A or selection of at least a portion of the second mission 502B to define a composite mission, the system may not enable the selection of at least a portion of the first mission 502A and at least a portion of the second mission 502B for merging into the composite mission based on determining that the first mission 502A and the second mission 502B are not candidates for merging.

If the system determines that the comparison result does satisfy (e.g., exceeds, matches, etc.) the threshold, the system may determine that the first mission 502A and the second mission 502B are candidates for merging. Based on determining that the first mission 502A and the second mission 502B are candidates for merging, the system may provide (e.g., a representation of) the first mission 502A and the second mission 502B (with or without one or more missions that the system determined are a candidate for merging with the first mission 502A and the second mission 502B, if any) for display simultaneously via a user interface. For example, the system may instruct simultaneous display of a representation of the first mission 502A and a representation of the second mission 502B via a user interface (e.g., overlaid on a representation of the environment).

The system may receive an input via the user interface indicating at least a portion of the first mission 502A or at least a portion of the second mission 502B for definition of a composite mission. By instructing display simultaneously of the first mission 502A and the second mission 502B, the system may enable selection of at least a portion of the first mission 502A and/or selection of at least a portion of the second mission 502B to define a composite mission based on determining that the first mission 502A and the second mission 502B are candidates for merging. Further, by instructing display simultaneously of the first mission 502A and the second mission 502B, the system can obtain input identifying operations to apply to the first mission 502A and/or the second mission 502B to define the composite mission.

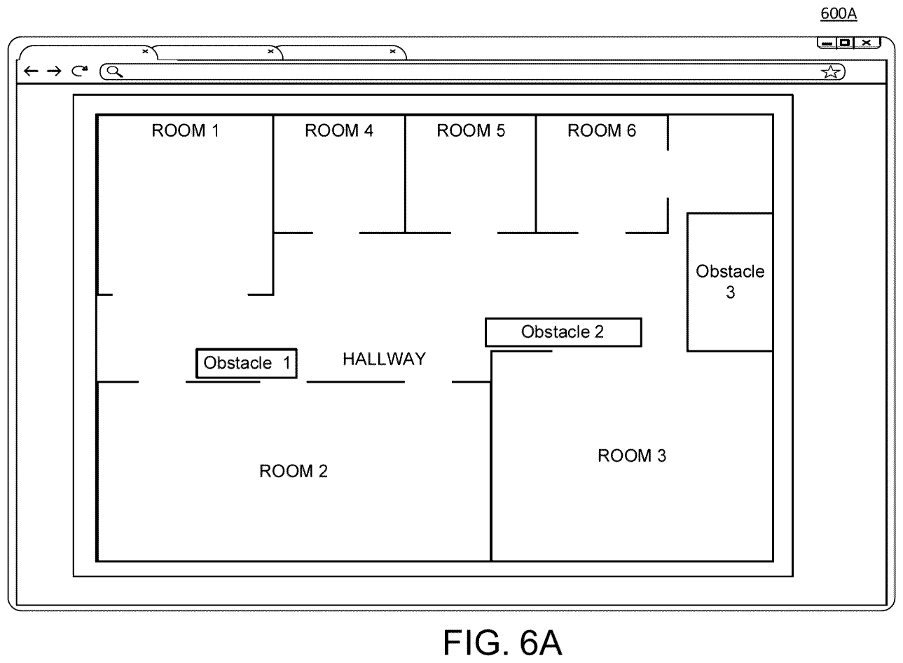

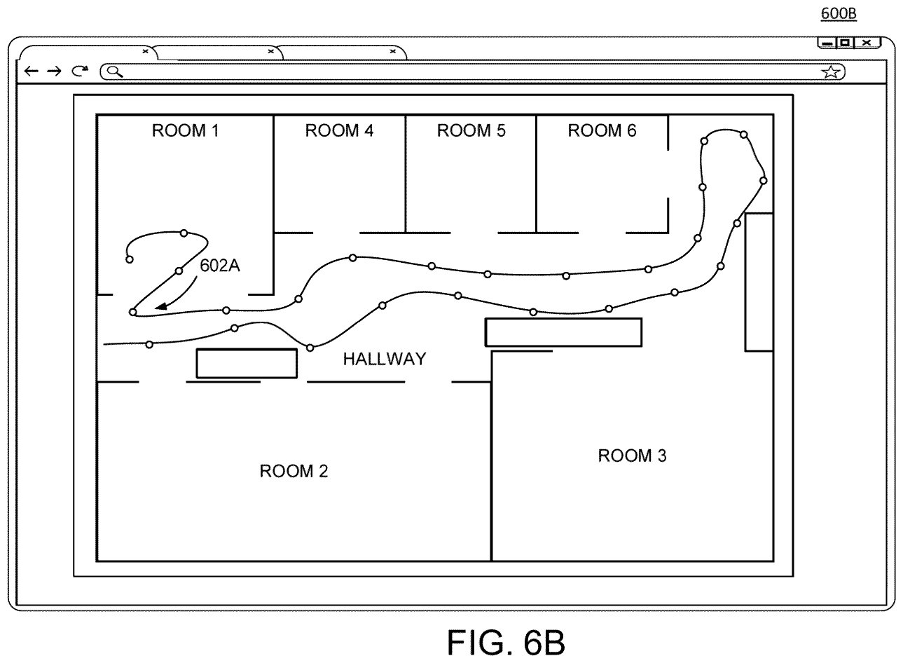

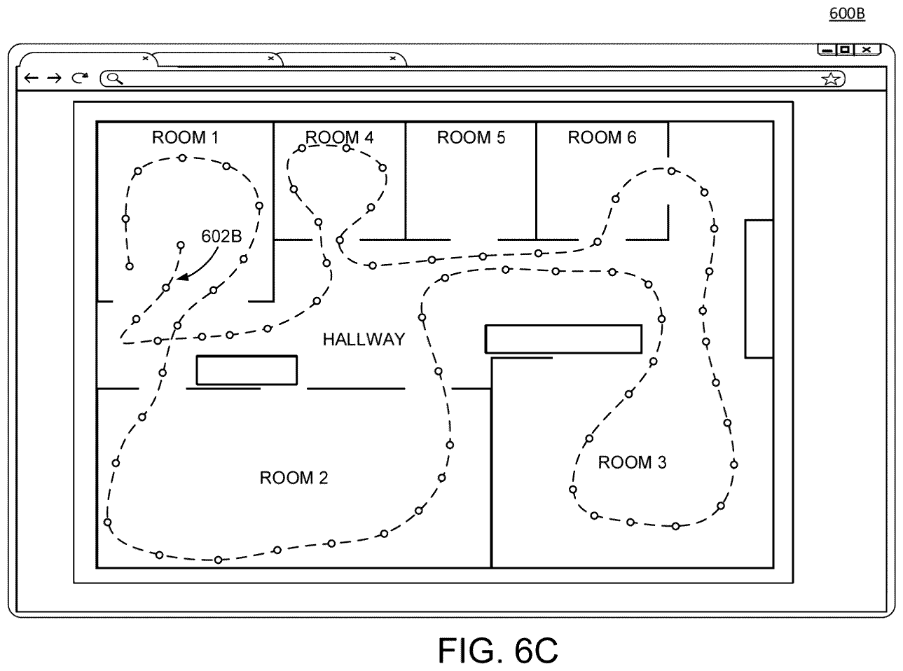

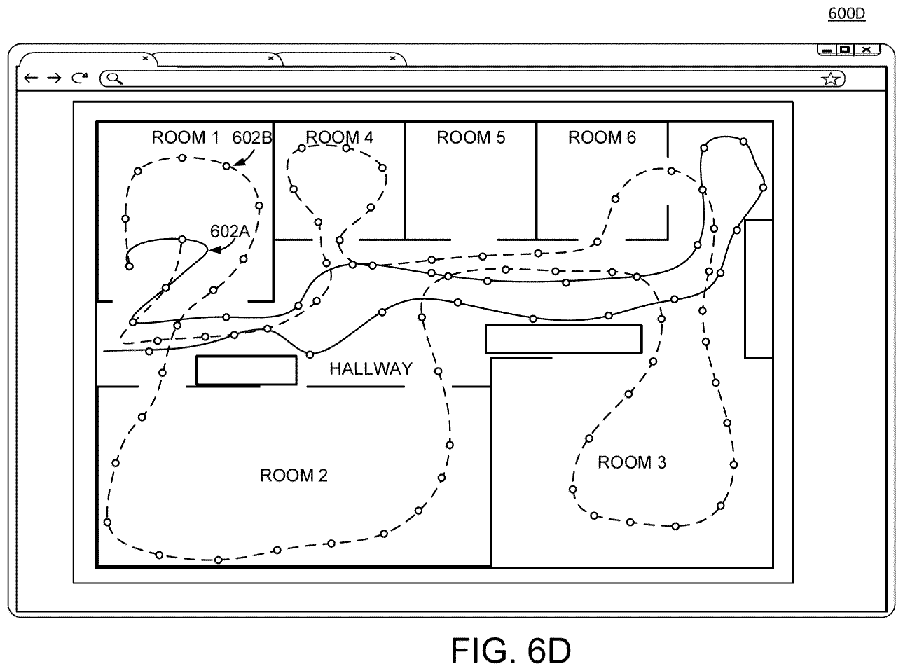

FIG. 6A is a schematic view of an example user interface 600A indicating an environment (e.g., a site). The user interface 600A reflects an environment model (e.g., a site model) of an environment. For example, the environmental model may be, may include, or may be a representation of a floorplan, a blueprint, a computer-aided design (“CAD”) model, a map, a graph, a drawing, a layout, a figure, an architectural plan, a site plan, a diagram, an outline, a facilities representation, a geo-spatial rendering, a satellite view of the environment, etc.

The environmental model may indicate one or more features associated with one or more objects, obstacles, structures, or entities within the environment. For example, the objects, obstacles, structures, or entities may include one or more walls, ceilings, ground surfaces, stairs, rooms, humans, robots, vehicles, toys, pallets, boxes, machines, rocks, or other objects, obstacles, structures, or entities that may affect the movement of the robot as the robot traverses the site. The objects, obstacles, structures, or entities may include static objects, obstacles, structures, or entities (e.g., obstacles that are not capable of self-movement) and/or dynamic objects, obstacles, structures, or entities (e.g., obstacles that are capable of self-movement). Further, the objects, obstacles, structures, or entities may include objects, obstacles, structures, or entities that are integrated into the site (e.g., the walls, stairs, the ceiling, etc.) and objects, obstacles, structures, or entities that are not integrated into the site (e.g., a ball on the floor or on a stair).

In the example of FIG. 6A, the environmental model indicates a hallway, Room 1, Room 2, Room 3, Room 4, Room 5, Room 6, and Obstacle 1, Obstacle 2, and Obstacle 3. For example, Obstacle 1, Obstacle 2, and Obstacle 3 may include boxes, pallets, machines, etc. It will be understood that the environmental model may include more, less, or different objects, obstacles, structures, or entities.

FIG. 6B is a schematic view of an example user interface 600B indicating a mission 602A of a robot in an environment. The user interface 600B reflects the mission 602A (e.g., a virtual representation of the mission 602A) relative to an environment map. A system may instruct display of the user interface 600B based on traversal of the environment by a robot (and/or definition of the mission 602A). The mission 602A may be based on mission data including a set of route waypoints and a set of route edges connecting the set of route waypoints and indicating a route of the robot through the environment. In the example of FIG. 6B, the user interface 600B reflects a set of circles corresponding to the set of route waypoints and a set of lines connecting the set of circles corresponding to the set of route edges. In some cases, the mission data may associate all or a portion of the set of route waypoints with one or more actions.

FIG. 6C is a schematic view of an example user interface 600C indicating a mission 602B of a robot in an environment. The user interface 600C reflects the mission 602B (e.g., a virtual representation of the mission 602B) relative to an environment map. A system may instruct display of the user interface 600C based on traversal of the environment by a robot (and/or definition of the mission 602B). The mission 602B may be based on mission data including a set of route waypoints and a set of route edges connecting the set of route waypoints and indicating a route of the robot through the environment. In some cases, the mission data may associate all or a portion of the set of route waypoints with one or more actions.

As discussed above, while the mission 602A and the mission 602B may correspond to routes through the same environment, the mission 602A and the mission 602B may be defined based on the traversal of the environment by the same robot or different robots. For example, the system may define the mission 602A based on traversal of the environment by a first robot and the system (or a separate system) may define the mission 602B based on traversal of the environment by a second robot. In another example, one or more systems may define the mission 602A and the mission 602B based on traversal of the environment by the same robot. In some cases, one or more systems may define the mission 602A and the mission 602B based on a single traversal of the environment. For example, one or more systems may define the mission 602A based on a first portion of a traversal of the environment (or traversal of a first portion of the environment) and the one or more systems may define the mission 602B based on a second portion of the traversal of the environment (or traversal of a second portion of the environment).

FIG. 6D is a schematic view of an example user interface 600D indicating a mission of a robot in an environment. The user interface 600C reflects the mission 602A and the mission 602B (e.g., a virtual representation of the mission 602A and the mission 602B) relative to an environment map. The mission 602A and the mission 602B may correspond to one or more routes of one or more robots overlaid on the same environment map. In the example of FIG. 6D, the user interface 600D reflects a route (e.g., one or more route edges) corresponding to the mission 602A using a solid line and reflects a route corresponding to the mission 602B using a dashed line.

A system may instruct display of the user interface 600D based on determining that fiducial data associated with the mission 602A corresponds to (e.g., matches, is within a threshold range of similarity of, etc.) fiducial data associated with the mission 602B. For example, the system may compare a fiducial marker associated with the mission 602A with a fiducial marker associated with the mission 602B.

The system may instruct display of the user interface such that a user can provide a selection of at least a portion of the mission 602A and/or at least a portion of the mission 602B to define a composite mission (and generate corresponding composite mission data). In some cases, a user can provide a selection of at least a portion of mission data.

In some cases, the system may instruct display of the user interface such that a user can provide an input to provide user-defined data to define the composite mission. For example, the input can indicate a user-defined action, a user-defined route waypoint, a user-defined route edge, a user-defined mission, etc. to define the composite mission (and generate corresponding composite mission data).

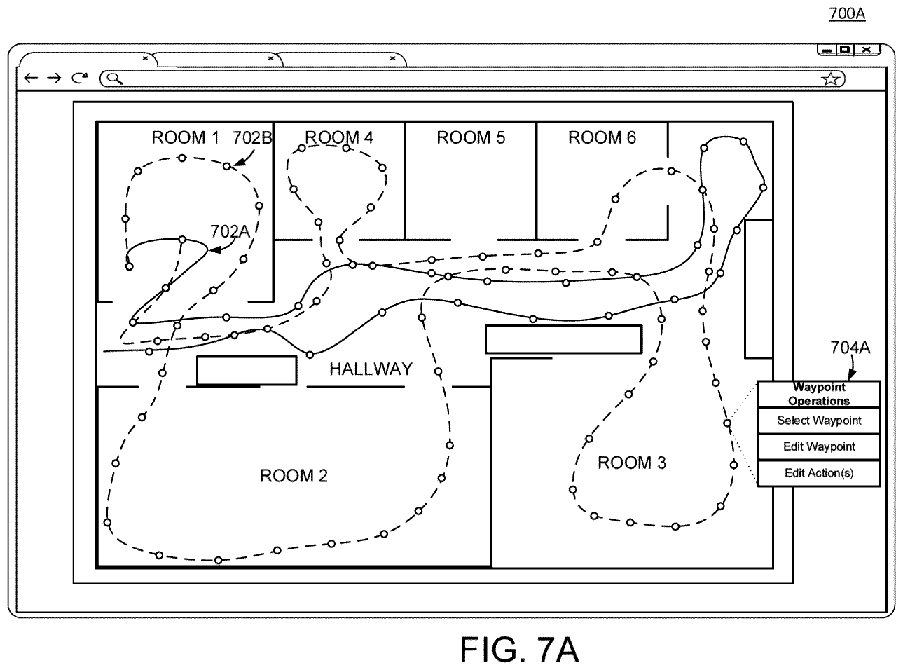

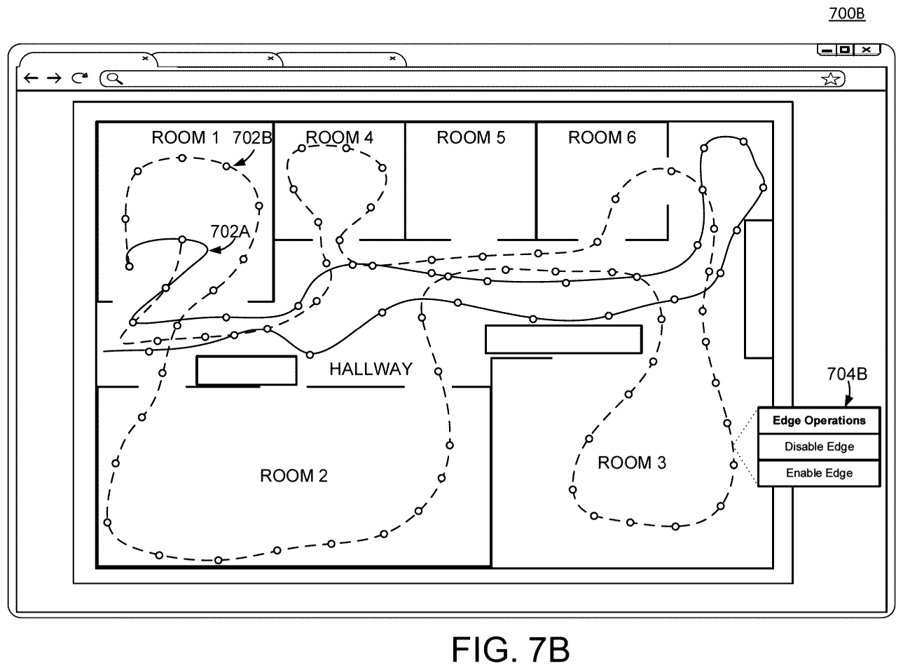

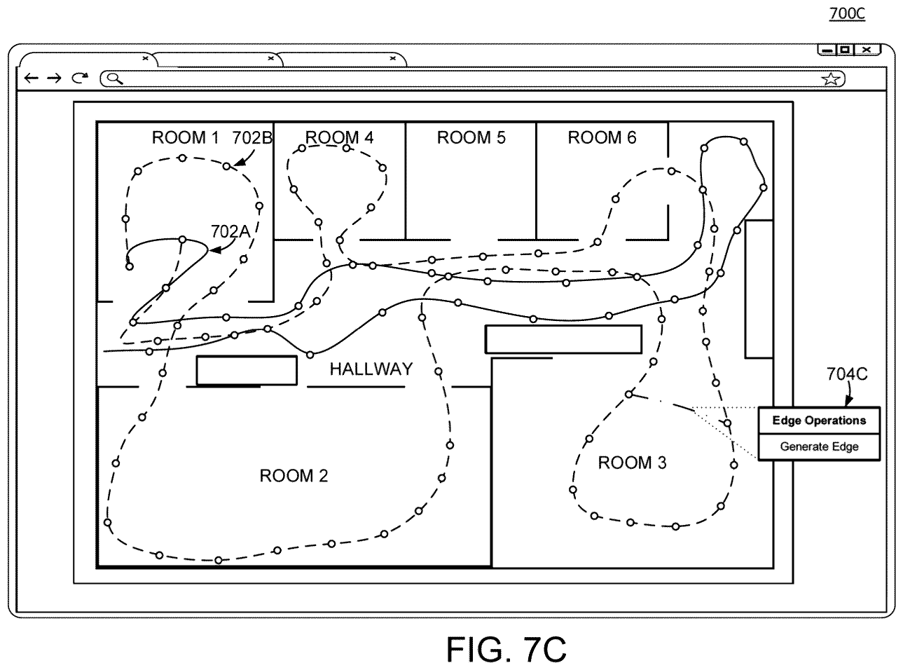

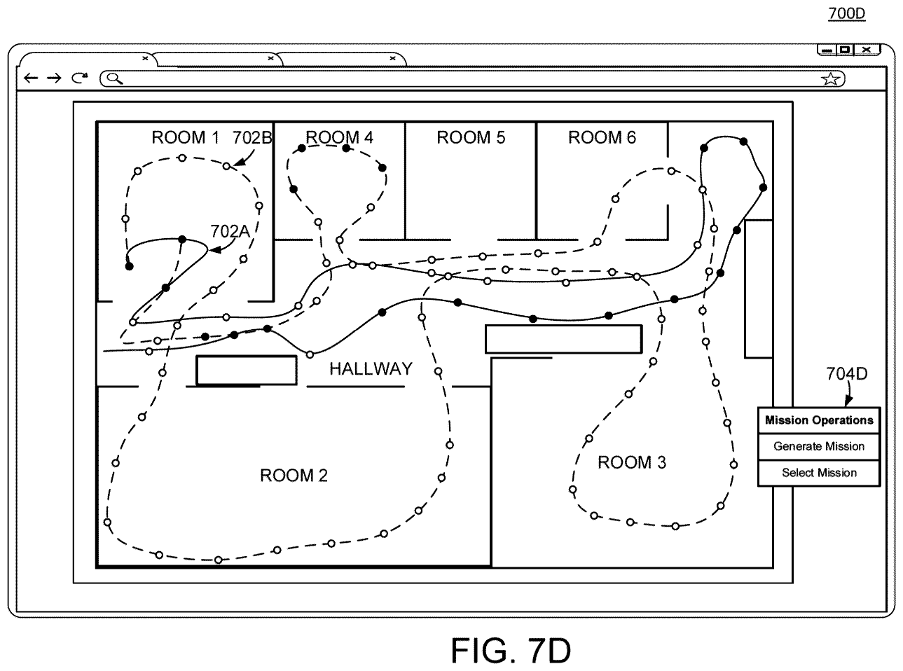

FIG. 7A is a schematic view of an example user interface 700A indicating an environment and one or more waypoint operations 704A. The user interface 700A reflects a mission 702A and a mission 702B (e.g., based on a system determining that fiducial data associated with the mission 702A corresponds to fiducial data associated with the mission 702B). In the example of FIGS. 7A, 7B, 7C, and 7D, the user interface 700A, the user interface 700B, the user interface 700C, and the user interface 700D reflect a route (e.g., one or more route edges) corresponding to the mission 702A using a solid line and reflects a route corresponding to the mission 702B using a dashed line.

The system may instruct display of the user interface via a user computing device. In some cases, one or more systems may define the mission 702A and/or the mission 702B based on the traversal of the environment by one or more robots and the system may instruct display of the user interface via a user computing device of the one or more robots (e.g., a display of the one or more robots, a computing device of a fleet manager of the one or more robots, etc.). In some cases, one or more systems may define the mission 702A and/or the mission 702B based on the traversal of the environment by one or more robots and the system may instruct display of the user interface via a user computing device not associated with the one or more robots (e.g., a display of a different robot, a computing device of a fleet manager of a different robot, etc.).

Based on an interaction with the user interface, the system may obtain an input and, in response to the input, the system may identify one or more waypoint operations 704A and instruct display of one or more waypoint operations 704A. For example, the interaction may include clicking on, hovering over, or otherwise interacting with a representation of one or more route waypoints (and one or more corresponding actions) associated with the mission 702A and/or the mission 702B. The one or more waypoint operations 704A for a route waypoint may be mission-agnostic operations in that the one or more waypoint operations 704A may apply to all or a portion of the missions (e.g., all of the missions associated with the route waypoint).

The one or more waypoint operations 704A may include operations to edit an action associated with a route waypoint and/or operations to edit the route waypoint. As seen in FIG. 7A, the one or more waypoint operations 704A may include an operation to select the route waypoint, an operation to edit the route waypoint, and an operation to edit the action associated with the route waypoint. For example, the one or more waypoint operations 704A may include an operation to include the route waypoint in composite mission data, edit a location of the route waypoint, delete the route waypoint, edit a route waypoint identifier, edit an action identifier, edit an asset or equipment identifier, edit a timeout period for performing the action, edit metadata associated with the action (e.g., metadata tags), edit data to be captured in performing the action (e.g., a type of data, a robot identifier, a robot status, a position of the robot, one or more detected objects, obstacles, structures, or entities, a network status, etc.), edit a component (e.g., a sensor, an appendage, etc.) to perform the action, edit a distance associated with the action (e.g., a goal distance, a route waypoint distance, a distance from a route waypoint at which to perform the action, etc.), edit an action enablement (e.g., whether a particular action is enabled or disabled), edit a failure condition (e.g., what constitutes a failure to perform the action, execute a mission, and/or navigate to the route waypoint), edit a user prompt timeout period (e.g., edit a timeout period for requesting input), edit a number of reattempts to execute (e.g., a number of reattempts of execution of a mission, performance of an action, etc. after a failure), edit a failure behavior (e.g., a default behavior if a failure occurs such as return to dock, perform next action, etc.), etc.

In some cases, the one or more waypoint operations 704A may include operations to generate (e.g., define) a route waypoint. For example, the one or more waypoint operations 704A may include an operation to define a route waypoint (e.g., a previously undefined route waypoint) and link the route waypoint to a particular mission. In some cases, the system may enable definition of a route waypoint for a particular location without a robot navigating to the particular location (e.g., without instructing a robot to navigate to the particular location and/or without obtaining data from a robot that navigated to the particular location).

To define the route waypoint, the system may obtain an input and/or identify an interaction with the user interface 700A. For example, the interaction may include clicking on, hovering over, drawing, labeling, motioning, smoothing, dragging and dropping, typing in coordinates, or otherwise interacting with the user interface 700A to define a route waypoint and/or the input may include a definition of the route waypoint (e.g., using one or more coordinates). Based on the interaction, the system may identify a portion of the environment and define a route waypoint for the portion of the environment. In some cases, the system may obtain data defining the route waypoint (e.g., a set of coordinates).

The system may assign data to the defined route waypoint to enable localization by a robot. For example, the system may identify satellite-based position data associated with the portion of the environment and may assign the satellite-based position data to the route waypoint. In some cases, the system may interpolate data to assign to the defined route waypoint based on data associated with other route waypoints (e.g., route waypoints corresponding to the mission 702A and/or the mission 702B). For example, the system may identify one or more route waypoints, may identify a relationship between the one or more route waypoints and the defined route waypoint (e.g., a distance between, a correspondence between, etc.), may identify data (e.g., point cloud data) associated with the one or more route waypoints, may adjust the data based on the relationship (e.g., based on the distance between the one or more route waypoints and the defined route waypoint) to obtain adjusted data, and may assign the adjusted data to the defined route waypoint to enable localization using the adjusted data. Therefore, the system may enable a robot to perform localization relative to a defined waypoint (e.g., without a robot previously navigating to the defined waypoint).

In some cases, the one or more waypoint operations 704A may include operations to define a first route waypoint using data associated with a second route waypoint (e.g., an action, an asset or equipment identifier, a timeout period, metadata, data to be captured in performing the action, a component to perform the action, a distance associated with the action, an action enablement, a failure condition, a user prompt timeout period, a number of reattempts to execute, a failure behavior, etc.). For example, to define the route waypoint, the system may identify an interaction with the user interface 700A defining data to be copied to a first route waypoint from a second route waypoint and may define the first route waypoint according to the data.

An input may be received based on the one or more waypoint operations 704A and one or more values associated with the one or more waypoint operations (e.g., a value for a distance at which to perform an action). The system may define the composite mission based on the input (e.g., the one or more values). In some cases, the system may update one or more routes waypoints (including one or more missions that include the one or more route waypoints) according to the input.

FIG. 7B is a schematic view of an example user interface 700B indicating an environment and one or more edge operations 704B. The user interface 700B reflects the mission 702A and the mission 702B (e.g., based on a system determining that fiducial data associated with the mission 702A corresponds to fiducial data associated with the mission 702B). The one or more edge operations 704B may be mission-specific operations in that the one or more edge operations 704B may apply to a single mission.

Based on an interaction with the user interface, the system may obtain an input and, in response to the input, the system may identify one or more edge operations 704B and instruct display of the one or more edge operations 704B. For example, the interaction may include clicking on, hovering over, or otherwise interacting with a representation of a route edge associated with the mission 702A and/or the mission 702B.

The one or more edge operations 704B may include operations to disable and/or enable a route edge. As seen in FIG. 7B, the one or more edge operations 704B may include operations to enable a route edge within a mission and disable a route edge within one or more missions (e.g., locally or globally).

An input may be received based on the one or more edge operations 704B (e.g., indicating a disabled route edge, an enabled route edge, etc.). For example, the system may define one or more route edges that are enabled for one or more missions based on the input. The system may define the composite mission based on the input. In some cases, the system may dynamically update a mission based on the one or more route edges that are disabled or enabled according to the input.

FIG. 7C is a schematic view of an example user interface 700C indicating an environment and one or more edge operations 704C. The user interface 700C reflects the mission 702A and the mission 702B (e.g., based on a system determining that fiducial data associated with the mission 702A corresponds to fiducial data associated with the mission 702B). In the example of FIG. 7C, the user interface 700C reflects a route (e.g., one or more route edges) corresponding to the mission 702A using a solid line, reflects a route corresponding to the mission 702B using a first dashed line, and reflects a user-defined route edge using a second dashed line different from the first dashed line.

Based on an interaction with the user interface, the system may obtain an input and, in response to the input, the system may identify one or more edge operations 704C and instruct display of the one or more edge operations 704C. For example, the interaction may include clicking on, hovering over, drawing, labeling, motioning, smoothing, or otherwise interacting with the user interface 700C to define a route edge (e.g., not corresponding to the mission 702A and/or the mission 702B). In some cases, the system may enable a user to define a route edge for route waypoints where a distance between two or more route waypoints is less than or matches a threshold.

The one or more edge operations 704C may include operations to generate (e.g., define) a route edge. As seen in FIG. 7C, the one or more edge operations 704C may include operations to generate a route edge between one or more route waypoints.

In some cases, the one or more edge operations 704C may include operations to adjust a route edge (e.g., corresponding to the mission 702A and/or the mission 702B). For example, the operations to adjust a route edge may cause generation of another route edge (e.g., not corresponding to the mission 702A and/or the mission 702B) by performing an operation (e.g., smoothing, shortening, etc.) to adjust the route edge (e.g., corresponding to the mission 702A and/or the mission 702B).

In some cases, the system may process sensor data associated with a robot, determine that a portion of the environment has a probability of being unoccupied (e.g., by an obstacle, object, entity, or structure) based on processing the sensor data, determine that the probability satisfies (e.g., matches, exceeds) a threshold, and cause display, via the user interface 700C, of a suggested route edge between two route waypoints through the portion of the environment based on determining that the probability satisfies the threshold such that a user can accept or decline a suggested route edge.

In some cases, the system may perform point cloud matching for two or more route waypoints and may provide one or more suggested route edges based on performing the point cloud matching. For example, the system may process sensor data (e.g., point cloud data) associated with a robot, determine a similarity (e.g., correspondence) between sensor data associated with a first route waypoint and sensor data associated with a second route waypoint, determine the similarity satisfies a threshold, and cause display, via the user interface 700C, of a suggested route edge between the first route waypoint and the second route waypoint based on determining that the similarity satisfies a threshold.

In some cases, the system may instruct display of the one or more edge operations 704C for one or more first computing devices and may not instruct display of the one or more edge operations 704C for one or more second computing devices. For example, the system may authorize particular computing devices to provide input via the one or more edge operations 704C and may not authorize other computing devices to provide input via the one or more edge operations 704C.

An input may be received based on the one or more edge operations 704C and generate a route edge. For example, the system may generate a route edge for a particular mission based on an input. The system may define the composite mission based on the input. In some cases, the system may dynamically update a mission based on the generated route edge. For example, based on the input, the system may add the route edge from a mission.

FIG. 7D is a schematic view of an example user interface 700D indicating an environment and one or more mission operations 704D. The user interface 700A reflects the mission 702A and the mission 702B (e.g., based on a system determining that fiducial data associated with the mission 702A corresponds to fiducial data associated with the mission 702B). In the example of FIG. 7D, the user interface 700D reflects a route (e.g., one or more route edges) corresponding to the mission 702A using a solid line and reflects a route corresponding to the mission 702B using a dashed line. Further, the user interface 700D reflects a set of route waypoints or actions (associated with the mission 702A and the mission 702B) that are selected for a composite mission (e.g., based on an input) as solid circles (e.g., filled circles, bolded circles, etc.) and reflects a set of route waypoints or actions (associated with the mission 702A and the mission 702B) that are not selected for the composite mission (e.g., based on the input) as open circles (e.g., empty circles, hollow circles, etc.).

Based on an interaction with the user interface, the system may obtain an input and, in response to the input, the system may identify one or more mission operations 704D and instruct display of the one or more mission operations 704D. For example, the interaction may include clicking on, hovering over, or otherwise interacting with at least a portion of the mission 702A and/or at least a portion of the mission 702B (e.g., indicative of a route waypoint, a route edge, etc.).

The one or more mission operations 704D may include operations to define and/or select a composite mission based on a selection of one or more route waypoints, one or more route edges, and/or one or more actions. As seen in FIG. 7D, the one or more mission operations 704D may include an operation to define a composite mission for performance by a robot and an operation to select a previously defined mission for performance by a robot. In some cases, the user interface 700D may include an element to define a robot to perform the operation.

In some cases, the one or more mission operations 704D may include operations to edit the mission. For example, the one or more mission operations 704D may include an operation to edit a number of self-right attempts for a robot (e.g., prior to calling for help), edit a battery charge parameter (e.g., a minimum battery charge for the robot to be able to undock, a minimum battery charge for the robot to return to the dock, etc.), edit a shortcut parameter (e.g., whether shortcuts between route waypoints are permitted during performance of the mission), edit a route parameter (e.g., whether deviations from the route data of the mission are permitted), edit a features parameter (e.g., whether movers are expected in the environment of the robot, whether the robot is to avoid entities, objects, obstacles, and/or structures and/or a threshold distance to maintain from entities, objects, obstacles, and/or structures, etc.), edit a failure condition (e.g., what constitutes a failure to perform the action, execute a mission, and/or navigate to the route waypoint), edit a user prompt timeout period (e.g., edit a timeout period for requesting input), edit a number of reattempts to execute (e.g., a number of reattempts of execution of a mission, performance of an action, etc. after a failure), edit a failure behavior (e.g., a default behavior if a failure occurs such as return to dock, perform next action, etc.), etc.

Based on the one or more waypoint operations 704A, the one or more edge operations 704B, the one or more edge operations 704C, and the one or more mission operations 704D, the system can generate composite mission data (and/or update previously generated composite mission data) and define a corresponding composite mission.

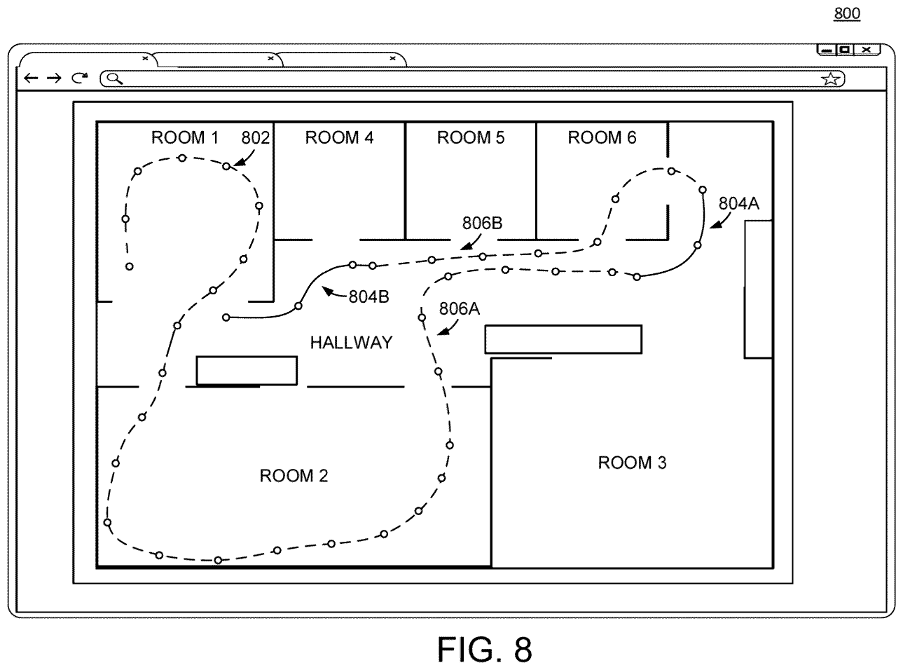

FIG. 8 is a schematic view of an example user interface 800 indicating an environment and a composite mission 802. The user interface 800 reflects a composite mission 802 for execution by a robot. A system may define the composite mission 802 based on one or more waypoint operations, the one or more edge operations, and the one or more mission operations. The system may define the composite mission 802 for execution by a robot by merging and/or filtering one or more missions (e.g., as recorded by the robot, one or more different robots, etc.) such that the composite mission 802 may include a first portion of a first mission, a second portion of a second mission, a third portion of a third mission, etc.

In the example of FIG. 8, the composite mission 802 includes a first portion of a first mission 804A, a second portion of the first mission 804B, a first portion of a second mission 806A, and a second portion of the second mission 806A. Further, to reflect portions of routes selected for the composite mission 802, the user interface 800 reflects portions of a route (e.g., one or more route edges) corresponding to the first mission using a solid line and portions of a route corresponding to the second mission using a dashed line.

To define the composite mission 802, a system may dynamically order the portions of the missions to define the composite mission (e.g., based on a time to execute the mission, a distance traversed by the robot to execute the mission, a time that the mission can be initialized, etc.). For example, the system can dynamically order one or more route waypoints, one or more route edges, one or more actions, etc. to minimize a time to perform the composite mission 802. Based on the dynamic ordering of the portions of the missions, a portion of a mission that was ordered at the start of the mission may be reordered after one or more portions of one or more other missions (or one or more other portions of the mission) within the composite mission.

In some cases, the system may order the portions of the missions based on an input defining the order. For example, the system may receive input via a user interface indicating an order for performance of one or more actions, an order at which to navigate to one or more route waypoints, etc.

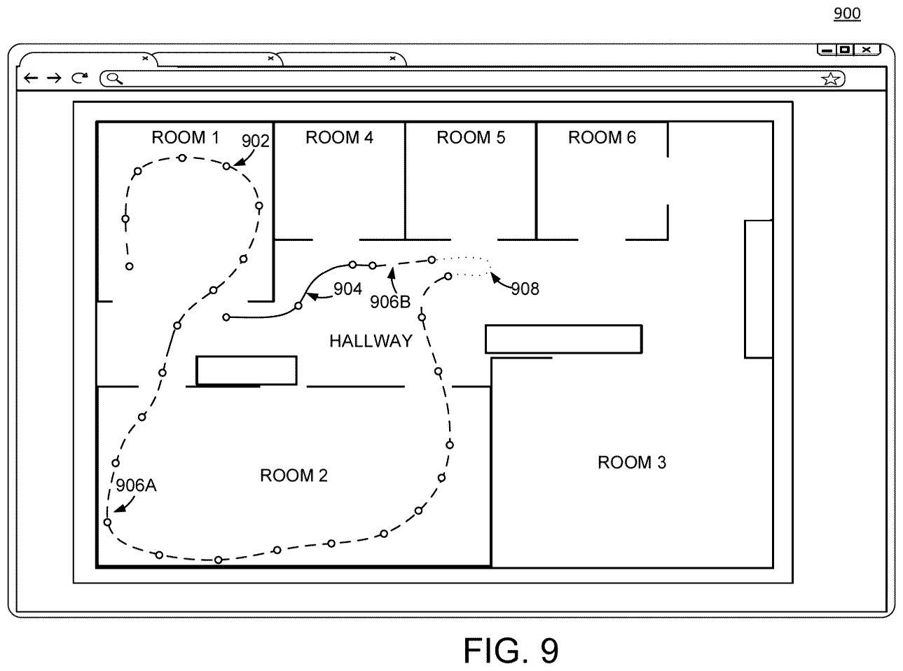

FIG. 9 is a schematic view of an example user interface 900 indicating an environment and a composite mission 902. The user interface 900 reflects a composite mission 902 for execution by a robot. A system may define the composite mission 902 based on one or more waypoint operations, the one or more edge operations (e.g., including one or more user-defined route edges), and the one or more mission operations.

In the example of FIG. 9, the composite mission 902 includes a portion of a first mission 904, a first portion of a second mission 906A, a second portion of the second mission 906A, and a user-defined route edge 908. Further, to reflect portions of routes selected for the composite mission 902, the user interface 900 reflects portions of a route (e.g., one or more route edges) corresponding to the first mission and using a solid line, portions of a route corresponding to the second mission using a first dashed line, and portions of a user-defined route edge using a second dashed line different from the first dashed line.

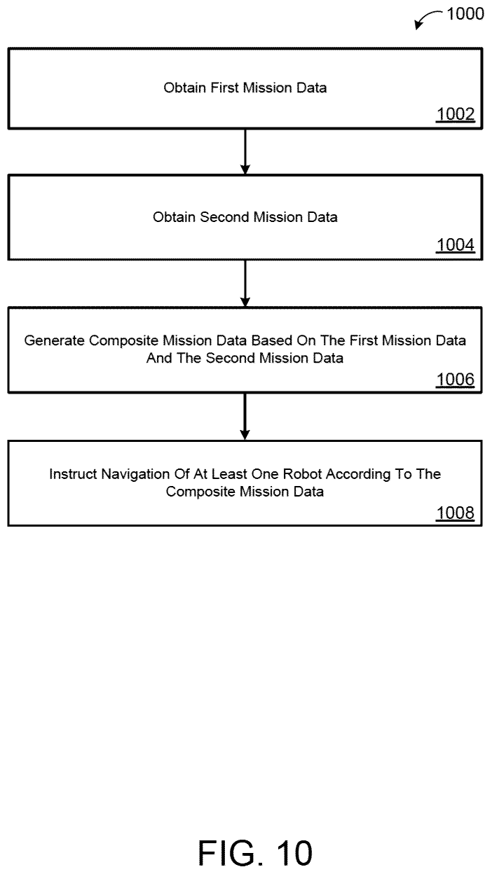

FIG. 10 shows a method 1000 executed by a computing system that obtains mission data, generates composite mission data, and instructs a robot (e.g., a mobile robot, a legged mobile robot, a two-legged mobile robot, or a four-legged mobile robot) to navigate according to the composite mission data, according to some examples of the disclosed technologies. The computing system may be similar, for example, to and/or may include the mission definition system 412, the mission execution system 402, the mission verification system 420A, the mission verification system 420B, the sensor system 430, the control system 470, the navigation system 406, the sensor pointing system 408, and/or the computing system 440, as discussed above, and may include memory and/or data processing hardware. For example, the computing system may be located on and/or externally to the robot.

At block 1002, the computing system obtains first mission data. The first mission data may be associated with a first mission (e.g., a first robot mission) and an environment. For example, the first mission may be a mission through the environment (e.g., to navigate through, to traverse, to perform one or more actions, etc. in the environment). The first mission may be a mission of a first robot (e.g., a mission recorded by the first robot, a mission based on traversal of an environment by the first robot, etc.).

The first mission data may indicate (e.g., may include, may be indicative of, etc.) one or more first route waypoints, one or more first route edges, and one or more first actions corresponding to the one or more first route waypoints. Further, the first mission data may link a first route waypoint of the one or more first route waypoints to a second route waypoint of the one or more first route waypoints via a first route edge of the one or more first route edges. The first mission data may further indicate a first action is associated with the second route waypoint.

The computing system (or a separate system) may record the first mission and generate the first mission data based on traversal of the environment by a robot (e.g., the first robot). In some cases, the first mission data may be indicative of the traversal of the environment by the robot, one or more interactions by the robot with the environment, an object, an obstacle, a structure, or an entity within the environment, and/or one or more actions performed by the robot within the environment.

At block 1004, the computing system obtains second mission data. The second mission data may be associated with a second mission (e.g., a second robot mission) and the environment. The second mission may be a mission of a second robot (e.g., a mission recorded by the second robot, a mission based on traversal of an environment by the second robot, etc.). In some cases, the second mission may be a mission of the first robot (e.g., the first mission and the second mission may be missions of the same robot). The second mission data may indicate (e.g., may include, may be indicative of, etc.) one or more second route waypoints, one or more second route edges, and one or more second actions corresponding to the one or more second route waypoints.

The computing system (or a separate system) may record the second mission and generate the second mission data based on traversal of the environment by a robot (e.g., the first robot, the second robot, etc.). For example, the computing system may record the second mission data and/or generate the second mission in response to the robot traversing the environment or as the robot traverses the environment.

In some cases, the computing system may obtain an input (e.g., user-defined data, selection data, etc.) via a user interface (e.g., a first user interface). The computing system may cause display of the user interface (e.g., identifying the first mission) based on the first mission data (e.g., an initial set of mission data associated with a first robot) and may obtain the input via the user interface (e.g., based on an interaction with the user interface) to generate mission data (e.g., indicating all or a portion of the initial set of mission data) for navigation of the same or a different robot (e.g., a second robot). For example, the input may be a selection of all or a portion (e.g., a subset) of one or more route waypoints, one or more route edge, and/or one or more actions associated with mission data. In another example, the input may indicate a user-defined route waypoint or route edge. In some cases, the computing may instruct display of a user interface (e.g., a second user interface) based on the generated mission data.

The input may be indicative of a route edge (e.g., a user-defined route edge, a selected route edge, etc.) between one or more route waypoints (e.g., the one or more route waypoints may be based on at least one of the first mission data or the second mission data). In some cases, the first mission data and/or the second mission data may indicate one or more first route edges between a first route waypoint and a second route waypoint and one or more second route edges between the second route waypoint and a third route waypoint and the input may be indicative of an additional route edge between the first route waypoint and the second route waypoint and/or a route edge between the first route waypoint and the third route waypoint.

The computing system may verify whether all or a portion of the first mission and all or a portion of the second mission are candidates for merging (e.g., can be merged) into a composite mission. In some cases, the computing system may verify whether all or a portion of the first mission data and all or a portion of the second mission data are candidates for merging into composite mission data. To verify whether all or a portion of the first mission and all or a portion of the second mission are candidates for merging, the computing system may determine whether first fiducial data (e.g., a fiducial) associated with the first mission corresponds to (e.g., matches, is within a threshold range of similarity, matches or exceeds a threshold probability of being the same as) second fiducial data (e.g., a fiducial) associated with the second mission by comparing the first fiducial data and the second fiducial data to obtain a comparison result, comparing the comparison result to a threshold, and determining if the comparison result satisfies the threshold. Based on determining that the first fiducial data corresponds to the second fiducial data (e.g., the comparison result satisfies the threshold), the computing system may verify that the first mission and the second mission are associated with common fiducial data (e.g., a common fiducial) and may verify that the first mission and the second mission are candidates for merging.

The computing system may identify an environment and may identify one or more missions associated with the environment (e.g., the first mission and the second mission). The computing system may identify the one or more missions are associated with the environment based on determining that fiducial data is associated with the environment and determining that the fiducial data corresponds to fiducial data associated with the one or more missions (e.g., first fiducial data associated with the first mission and second fiducial data associated with the second mission). Based on identifying that the one or more missions are associated with the environment, the computing system may identify one or more actions, one or more route waypoints, and/or one or more route edges indicated by mission data associated with the one or more missions as associated with the environment. The computing system may instruct display of a user interface that reflects the one or more actions, the one or more route waypoints, and/or the one or more route edges and may obtain, via the user interface, an input indicating a selection of at least a portion of the one or more actions, the one or more route waypoints, and/or the one or more route edges. As discussed below, the computing system may generate the composite mission data based on the selection.

At block 1006, the computing system generates (e.g., dynamically) composite mission data based on the first mission data and the second mission data. The composite mission data may be associated with a composite mission (e.g., a composite robot mission). For example, the computing system may generate composite mission data defining the composite mission. As discussed above, the computing system may generate the composite mission data based on one or more waypoint operations, one or more edge operations (e.g., including one or more user-defined route edges), and one or more mission operations.

To generate the composite mission data, the computing system may merge at least a portion of the first mission data and at least a portion of the second mission data. The composite mission data may include at least a portion of the first mission data and at least a portion of the second mission data. For example, the composite mission data may include a first portion of the first mission data, exclude a second portion of the first mission data, include a first portion of the second mission data, and exclude a second portion of the second mission data. In another example, the composite mission data may include at least a portion of the first mission data and may exclude the second mission data. In some cases, the computing system may merge at least a portion of the first mission and at least a portion of the second mission to define the composite mission.

In some cases, the computing system may not obtain second mission data and may generate the composite mission data based on an input indicative of a route edge between one or more route waypoints of the first mission data. For example, the first mission data may indicate one or more first route edges between the one or more route waypoints and the input may indicate a second route edge between the one or more route waypoints. The computing system may dynamically generate the composite mission data (e.g., associated with a composite mission, a second mission, etc.) based on the first mission data and the input.

In some cases, the computing system may obtain, via a user computing device, an input indicative of (e.g., defining) the at least a portion of the first mission data and/or the at least a portion of the second mission data. For example, the input may be indicative of one or more first route waypoints (e.g., to exclude from the composite mission data), one or more second route waypoints (e.g., to include in the composite mission data), one or more first route edges (e.g., to exclude from the composite mission data), and one or more second route edges (e.g., to include in the composite mission data. The composite mission data may include the one or more second route waypoints and the one or more second route edges and may exclude the one or more first route waypoints and the one or more first route edges.

In some cases, the input may be indicative of an order (e.g., an order of performance). For example, the order may indicate an order of performing one or more actions associated with the first mission data and one or more actions associated with the second mission data (e.g., first perform a first action associated with the first mission data, second perform a first action associated with the second mission data, third perform a fourth action associated with the first mission data, etc.). In some cases, the computing system may dynamically generate the order (e.g., the computing system may implement a machine learning model trained to output an order based on input indicative of mission data).

The composite mission data may indicate (e.g., may include, may be indicative of, etc.) one or more third route waypoints, one or more third route edges, and one or more third actions corresponding to the one or more third route waypoints. For example, the composite mission data may indicate at least a portion of the one or more first route waypoints, the one or more first route edges, and/or the one or more first actions corresponding to the first mission data and/or at least a portion of the one or more second route waypoints, the one or more second route edges, and the one or more second actions corresponding to the second mission data based on the order, as discussed above.

In one example, the first mission data may include a first route edge between a first route waypoint and a second route waypoint and a second route edge between the second route waypoint and a third route waypoint, the second mission data may include a third route edge between the third route waypoint and a fourth route waypoint and a fourth route edge between the fourth route waypoint and a fifth route waypoint, and the composite mission data may include a fifth route edge between the first route waypoint and one or more of the second route waypoint, the third route waypoint, the fourth route waypoint, and/or the fifth route waypoint.

In another example, the first mission may include a mission to navigate from a first route waypoint to a second route waypoint, the second mission may include a mission to navigate from the second route waypoint to a third route waypoint, and the composite mission may include a mission to navigate from the first route waypoint to the second route waypoint, to navigate from the first route waypoint to the second route waypoint, and/or to navigate from the second route waypoint to the third route waypoint.

In another example, the first mission may include a mission to navigate from a first route waypoint to a second route waypoint and from the second route waypoint to a third route waypoint, the second mission may include a mission to navigate from a fourth route waypoint to the second route waypoint and from the second route waypoint to a fifth route waypoint, and the composite mission may include a mission to navigate from the first route waypoint to the second route waypoint, the third route waypoint, the fourth route waypoint, and/or the fifth route waypoint and to navigate from the second route waypoint to the first route waypoint, the third route waypoint, the fourth route waypoint, and/or the fifth route waypoint.

In another example, the first mission may include a mission to perform (e.g., temporally first) a first action and perform (e.g., temporally second) a second action, the second mission may include a mission to perform (e.g., temporally first) a third action and perform (e.g., temporally second) a fourth action, and the composite mission may include a mission to perform (e.g., temporally first) the first action, the second action, the third action, and/or the fourth action and perform (e.g., temporally second) the first action, the second action, the third action, and/or the fourth action.

In some cases, the computing system may generate the composite mission data based on an input (e.g., a user-defined route edge). For example, the composite mission data may include a user-defined route edge. In some cases, the computing system may not obtain the second mission data and, instead, the computing system may generate the composite mission data based on the first mission data and the input. In some cases, the first mission data and/or the second mission data may include the input.

In some cases, the computing system may verify the composite mission, the composite mission data, at least one robot, the first mission data, and/or the second mission data). To perform the verification, the computing system may identify (e.g., obtain) one or more parameters of (e.g., indicated by) the composite mission data and/or one or more characteristics of at least one robot (e.g., based on receiving an input requesting navigation by the at least one robot according to the composite mission data) and may verify the composite mission data based on the one or more parameters and/or the one or more characteristics.

The one or more characteristics may indicate (e.g., may be indicative of a number, type, location, status, connectivity, etc. of) one or more sensors of the at least one robot (e.g., a lidar sensor, an image sensor, a microphone, etc.), one or more appendages of the at least one robot (e.g., an arm, a leg, a gripper, etc.), one or more processing units (e.g., a central processing unit, a graphics processing unit, etc.), a memory, a processing power, speed, or capability, a sensing power, speed, or capability, etc. For example, the one or more characteristics may indicate that two lidar sensors are connected to the at least one robot via a wired connection and are active, one lidar sensor is connected to the at least one robot via a wired connection and is inactive, and three lidar sensors are connected to the at least one robot via a wireless connection (e.g., remotely connected lidar sensors).

The one or more parameters (e.g., editable parameters) may indicate action data (e.g., one or more actions associated with one or more route waypoints), route data (e.g., one or more route waypoints, one or more route edges), sensor data (e.g., sensor data captured from the environment by one or more sensors of one or more robots), an order, etc. associated with the composite mission. In some cases, the computing system may identify (e.g., generate) the one or more parameters based on the composite mission data. In some cases, the composite mission data may include or indicate the action data and/or the route data. In some cases, the computing system may instruct display of a user interface indicative of the one or more parameters, obtain an input indicative of one or more edits to the one or more parameters via the user interface, and may generate edited mission data based on the input (and may store the edited mission data as the composite mission data). For example, the one or more edits may be one or more edits to one or more positions of one or more route waypoints with respect to an environment model.

To perform the verification, the computing system may compare the one or more characteristics with at least a portion of the composite mission data (e.g., the one or more parameters). For example, the computing system may compare the one or more characteristics with the one or more parameters, generate a comparison result based on comparing the one or more characteristics with the one or more parameters, and may determine whether the comparison result satisfies a threshold to determine whether to verify the composite mission data.

In some cases, the computing system may not verify all or a portion of the composite mission data (e.g., may flag the composite mission data) based on comparing the one or more characteristics with the at least a portion of the composite mission data. Based on comparing one or more characteristics with the at least a portion of the composite mission data and not verifying all or a portion of the composite mission data, the computing system may generate and instruct display of a user interface that includes an alert. For example, the alert may indicate all or a portion of the composite mission data that the computing system did not verify. In some cases, the user interface may include a prompt to verify all or a portion of the composite mission data and/or to approve a request to filter out the unverified composite mission data from the mission data.

In some cases, based on the computing system not verifying a portion of the composite mission data, the computing system may filter the portion of the composite mission data and may generate filtered composite mission data. The computing system may instruct navigation of the at least one robot based on the filtered composite mission data as discussed below.

The computing system may store the composite mission data (e.g., in memory). For example, the computing system may store the composite mission data in local memory such that one or more other robots may execute the composite mission.

At block 1008, the computing system instructs (e.g., commands, controls, etc.) navigation of at least one robot according to the composite mission data. In some cases, the computing system may instruct navigation of the at least one robot based on (e.g., in response) to generating and/or verifying the composite mission data. The at least one robot may include at least one of the first robot, the second robot, and/or one or more third robots. In some cases, all or a portion of the first robot, the second robot, and/or the one or more third robots may have different characteristics. For example, the first robot may have one or more first characteristics and the second robot may have one or more second characteristics.

The computing system may instruct display of a user interface that reflects the composite mission via a computing device (e.g., a user computing device). In some cases, the computing system may obtain an input indicative of one or more display parameters (e.g., a scale, a resolution, a brightness, etc.). The computing system may instruct display of the user interface according to the one or more display parameters. The user interface may reflect the composite mission (e.g., a representation of the composite mission) overlaid on a representation of the environment (e.g., an environment model). For example, the computing system may obtain an environmental model associated with the environment and may generate the user interface based on the environmental model. In some cases, the user interface may reflect the composite mission data overlaid on a representation of the environment.

In some cases, the computing system may instruct display of a user interface that reflects the first mission data (e.g., first sensor data of the first mission data) and/or the second mission data (e.g., second sensor data of the second mission data) via a computing device. The user interface may reflect the first mission data (e.g., a first virtual representation of the first sensor data) and/or the second mission data (e.g., a second virtual representation of the second sensor data) overlaid on a representation of the environment.

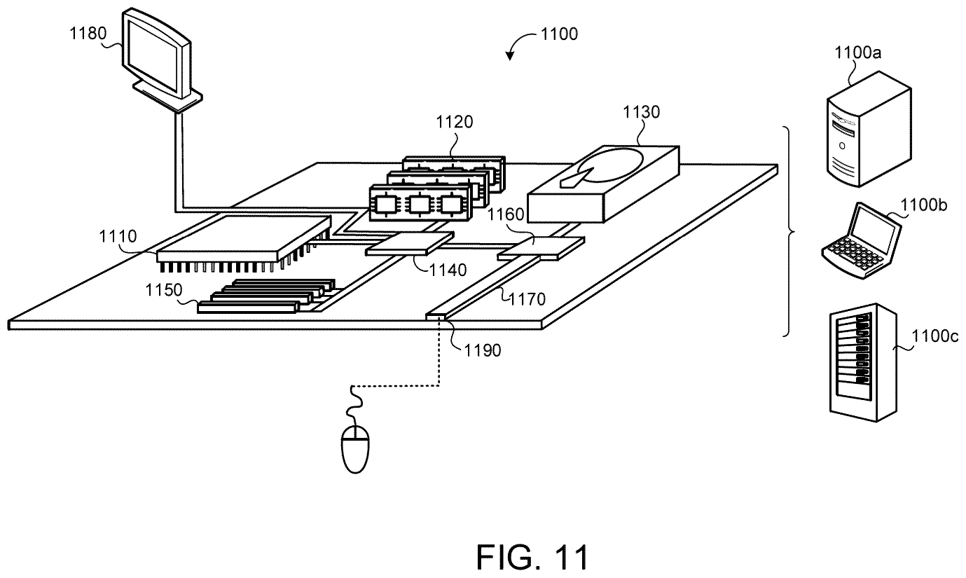

FIG. 11 is schematic view of an example computing device 1100 that may be used to implement the systems and methods described in this document. The computing device 1100 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1100 includes a processor 1110, memory 1120 (e.g., non-transitory memory), a storage device 1130, a high-speed interface/controller 1140 connecting to the memory 1120 and high-speed expansion ports 1150, and a low-speed interface/controller 1160 connecting to a low-speed bus 1170 and a storage device 1130. All or a portion of the processor 1110, the memory 1120, the storage device 1130, the high-speed interface/controller 1140, and/or the high-speed expansion ports 1150 may be interconnected using various busses, and may be mounted on a common motherboard or in other manners as appropriate. The processor 1110 can process instructions for execution within the computing device 1100, including instructions stored in the memory 1120 or on the storage device 1130 to display graphical information for a graphical user interface (GUI) on an external input/output device, such as display 11110 coupled to the high-speed interface/controller 1140. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1120 stores information non-transitorily within the computing device 1100. The memory 1120 may be a computer-readable medium, a volatile memory unit(s), or non-volatile memory unit(s). The memory 1120 may be physical devices used to store programs (e.g., sequences of instructions) or data (e.g., program state information) on a temporary or permanent basis for use by the computing device 1100. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1130 is capable of providing mass storage for the computing device 1100. In some implementations, the storage device 1130 is a computer-readable medium. In various different implementations, the storage device 1130 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1120, the storage device 1130, or memory on processor 1110.

The high-speed interface/controller 1140 may manage bandwidth-intensive operations for the computing device 1100, while the low-speed interface/controller 1160 may manage lower bandwidth-intensive operations. Such allocation of duties is exemplary only. In some implementations, the high-speed interface/controller 1140 may be coupled to the memory 1120, the display 1180 (e.g., through a graphics processor or accelerator), and to the high-speed expansion ports 1150, which may accept various expansion cards (not shown). In some implementations, the low-speed interface/controller 1160 may be coupled to the storage device 1130 and a low-speed expansion port 1190. The low-speed expansion port 1190, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1100a or multiple times in a group of such servers, as a laptop computer 1100b, or as part of a rack server system 1100c.

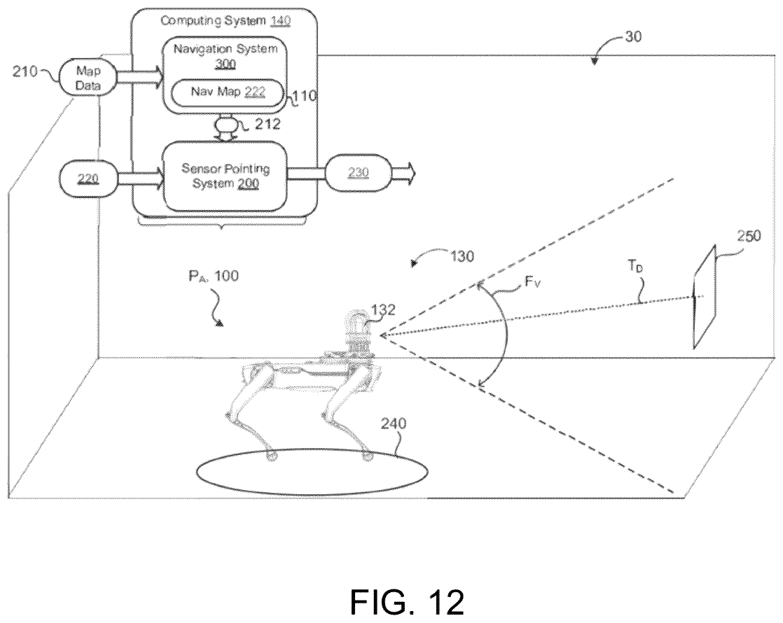

FIG. 12 is a schematic view of a robot 100 with a sensor pointing system 200 according to another embodiment. The embodiment of FIG. 12 is similar to the embodiment of FIG. 2, except the robot 100 includes a specific configuration of a PTZ senor 132 shown in FIG. 12.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user. In certain implementations, interaction is facilitated by a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described above can be combined to provide further embodiments. Indeed, the methods and systems described herein may be embodied in a variety of other forms; furthermore, various omissions, substitutions, and changes in the form of the methods and systems described herein may be made without departing from the spirit of the disclosure. Accordingly, other implementations are within the scope of the following claims.

What is claimed is:

1. A computer-implemented method comprising:
obtaining, by data processing hardware, first mission data associated with a first robot mission;
obtaining, by the data processing hardware, second mission data associated with a second robot mission;
generating, by the data processing hardware, composite mission data based on the first mission data and the second mission data, wherein the composite mission data comprises at least a portion of the first mission data and at least a portion of the second mission data; and
instructing, by the data processing hardware, navigation of at least one robot according to the composite mission data.

2. The computer-implemented method of claim 1, further comprising:
identifying one or more characteristics of the at least one robot, wherein the one or more characteristics are indicative of one or more of a sensor, an arm, a gripper, a processing unit, a processing capability, or a sensing capability of the at least one robot; and
verifying the composite mission data based on the one or more characteristics.

3. The computer-implemented method of claim 1, further comprising:
identifying one or more characteristics of the at least one robot;
comparing the one or more characteristics with at least a portion of the composite mission data; and
instructing display of a user interface based on comparing the one or more characteristics with at least a portion of the composite mission data, wherein the user interface comprises an alert.

4. The computer-implemented method of claim 1, wherein the first robot mission is associated with a first robot, and wherein the second robot mission is associated with a second robot.

5. The computer-implemented method of claim 1, wherein the first mission data is indicative of one or more waypoints, one or more edges, and one or more actions, wherein the first mission data links a first waypoint of the one or more waypoints to a second waypoint of the one or more waypoints via a first edge of the one or more edges, and wherein the first mission data indicates a first action is associated with the second waypoint.

6. The computer-implemented method of claim 1, further comprising:
obtaining, via a user computing device, input indicative of an edge between one or more waypoints, wherein the one or more waypoints are based on at least one of the first mission data or the second mission data, wherein generating the composite mission data is further based on the input.

7. The computer-implemented method of claim 1, wherein at least one of the first mission data or the second mission data indicates one or more first edges between a first waypoint and a second waypoint, the computer-implemented method further comprising:
obtaining, via a user computing device, input indicative of a second edge between the first waypoint and the second waypoint, wherein generating the composite mission data is further based on the input.

8. The computer-implemented method of claim 1, further comprising:
obtaining, via a user computing device, input indicative of the at least a portion of the first mission data and the at least a portion of the second mission data, wherein the at least a portion of the first mission data comprises one or more first waypoints and one or more first actions, and wherein the at least a portion of the second mission data comprises one or more second waypoints and one or more second actions.

9. The computer-implemented method of claim 1, further comprising:
obtaining, via a user computing device, input indicative of the at least a portion of the first mission data and the at least a portion of the second mission data, wherein the at least a portion of the first mission data comprises one or more first waypoints and one or more first actions, wherein the at least a portion of the second mission data comprises one or more second waypoints and one or more second actions, and wherein the composite mission data comprises the one or more first waypoints, the one or more second waypoints, the one or more first actions, and the one or more second actions.

10. The computer-implemented method of claim 1, further comprising:
obtaining, via a user computing device, input indicative of the at least a portion of the first mission data and the at least a portion of the second mission data and an order of performance, wherein the at least a portion of the first mission data comprises one or more first waypoints and one or more first actions, wherein the at least a portion of the second mission data comprises one or more second waypoints and one or more second actions, and wherein the composite mission data comprises the one or more first waypoints, the one or more second waypoints, the one or more first actions, and the one or more second actions based on the order of performance.

11. The computer-implemented method of claim 1, wherein the first mission data comprises a first edge between a first waypoint and a second waypoint and a second edge between the second waypoint and a third waypoint, wherein the second mission data comprises a third edge between the third waypoint and a fourth waypoint and a fourth edge between the fourth waypoint and a fifth waypoint, and wherein the composite mission data comprises a fifth edge between the first waypoint and the fifth waypoint.

12. The computer-implemented method of claim 1, wherein the first robot mission comprises a mission to navigate from a first waypoint to a second waypoint, wherein the second robot mission comprises a mission to navigate from the second waypoint to a third waypoint, and wherein the composite mission data is associated with a third robot mission comprising a mission to navigate from the first waypoint to the second waypoint and from the second waypoint to the third waypoint.

13. The computer-implemented method of claim 1, wherein the first robot mission comprises a mission to navigate from a first waypoint to a second waypoint and from the second waypoint to a third waypoint, wherein the second robot mission comprises a mission to navigate from a fourth waypoint to the second waypoint and from the second waypoint to a fifth waypoint, and wherein the composite mission data is associated with a third robot mission comprising a mission to navigate from the first waypoint to the second waypoint and from the second waypoint to the fifth waypoint.

14. The computer-implemented method of claim 1, wherein the first robot mission comprises a mission to perform a first action and a second action, wherein the second robot mission comprises a mission to perform a third action and a fourth action, and wherein the composite mission data is associated with a third robot mission comprising a mission to perform the first action and the fourth action.

15. The computer-implemented method of claim 1, wherein the first robot mission comprises a mission to first perform a first action and second perform a second action, wherein the second robot mission comprises a mission to first perform a third action and second perform a fourth action, and wherein the composite mission data is associated with a third robot mission comprising a mission to first perform the fourth action and second perform the first action.

16. The computer-implemented method of claim 1, further comprising:
obtaining, via a user computing device, input indicative of one or more first waypoints and one or more second waypoints, wherein the composite mission data comprises the one or more second waypoints, and wherein the composite mission data excludes the one or more first waypoints.

17. The computer-implemented method of claim 1, further comprising:
obtaining, via a user computing device, input indicative of one or more first edges and one or more second edges, wherein the composite mission data comprises the one or more second edges, and wherein the composite mission data excludes the one or more first edges.

18. The computer-implemented method of claim 1, further comprising:
verifying that the first mission data and the second mission data are associated with a common fiducial.

19. The computer-implemented method of claim 1, further comprising:
instructing display of a user interface, wherein the user interface reflects a representation of the composite mission data overlaid on an environment model.

20. A system comprising:
data processing hardware; and
memory in communication with the data processing hardware, the memory storing instructions that when executed on the data processing hardware cause the data processing hardware to:
obtain first mission data associated with a first robot mission;
obtain second mission data associated with a second robot mission;
generate composite mission data based on the first mission data and the second mission data, wherein the composite mission data comprises at least a portion of the first mission data and at least a portion of the second mission data; and
instruct navigation of at least one robot according to the composite mission data.

21. The system of claim 20, wherein the first robot mission is associated with a first robot, wherein the second robot mission is associated with a second robot, wherein the first robot has one or more first characteristics, and wherein the second robot has one or more second characteristics.

22. The system of claim 20, wherein at least one of the first mission data and the second mission data indicate a first edge between a first waypoint and a second waypoint and a second edge between the second waypoint and a third waypoint, wherein execution of the instructions on the data processing hardware further causes the data processing hardware to:
obtain, via a user computing device, input indicative of a third edge between the first waypoint and the third waypoint, wherein generating the composite mission data is further based on the input.

23. A robot comprising:
at least two legs;
data processing hardware; and
memory in communication with the data processing hardware, the memory storing instructions that when executed on the data processing hardware cause the data processing hardware to:
obtain first mission data associated with a first robot mission;
obtain second mission data associated with a second robot mission;
generate composite mission data based on the first mission data and the second mission data, wherein the composite mission data comprises at least a portion of the first mission data and at least a portion of the second mission data; and
instruct navigation of the robot using the at least two legs according to the composite mission data.

24. The robot of claim 23, wherein execution of the instructions on the data processing hardware further causes the data processing hardware to:
obtain, via a user computing device, input indicative of the at least a portion of the first mission data and the at least a portion of the second mission data.

25. The robot of claim 23, wherein the first robot mission is associated with a first robot, wherein the second robot mission is associated with a second robot, and wherein the robot comprises a third robot.
